(19) United States
(12) Patent Application Publication
(10) Pub. No.: US 2011/0255907 A1
(43) Pub. Date: Oct. 20, 2011

(54) TONER DISCHARGING DEVICE, TONER CARTRIDGE AND IMAGE FORMING APPARATUS

(76) Inventors: Koichi MIHARA, Osaka (JP); Takafumi NAGAI, Osaka (JP)

(21) Appl. No.: 13/087,756

(22) Filed: Apr. 15, 2011

(30) Foreign Application Priority Data
Apr. 15, 2010 (JP) P2010-094497

(51) Int. Cl. G03G 15/08

(52) U.S. Cl. 399/263

(57) ABSTRACT

A toner discharging device, a toner cartridge and an image forming apparatus in which occurrence of a locking phenomenon can be suppressed are provided. A toner discharging device includes a discharge container having a wall portion which defines an internal space thereof and has a reception port and a discharge port, and a discharge member including a rotation shaft and a discharge blade as a decay spiral blade. At least a part of the wall portion of the discharge container surrounds the discharge blade along an axial line direction of the rotation shaft, and the discharge port is formed on the part of the wall portion.

### CROSS-REFERENCE TO RELATED APPLICATION

This application claims priority to Japanese Patent Application No. 2010-094497, which was filed on Apr. 15, 2010, the contents of which are incorporated herein by reference in its entirety.

### BACKGROUND OF THE TECHNOLOGY

1. Field of the Technology

The present technology relates to a toner discharging device, a toner cartridge, and an image forming apparatus.

2. Description of Related Art

An electrophotographic image forming apparatus forms images by performing development using toner contained in a developing device. In the field of such an image forming apparatus, a toner cartridge that supplies toner to the developing device is known. The toner cartridge is configured such that the toner contained in the toner cartridge is supplied to the developing device when the toner in the developing device is consumed by image formation and the amount thereof becomes insufficient.

For example, Japanese Unexamined Patent Publication JP-A 2006-235255 discloses a toner cartridge which includes a storage container which stores toner, a discharge container extended from the storage container and having a discharge port through which toner is discharged, and a discharge member which conveys toner in the storage container to the discharge container and discharges the toner through the discharge port.

Moreover, Japanese Unexamined Patent Publication JP-A 2008-32769 discloses a discharger which includes a discharge container having a discharge port through which toner is discharged and a discharge member which discharges toner in the discharge container through the discharge port. The discharge member disclosed in JP-A 2008-32769 includes a rotation shaft and two spiral blades provided around the rotation shaft, and the two spiral blades are configured so as to convey toner in opposite directions.

In general, when a toner cartridge is transported or left unused for a long period, the toner in the toner cartridge decreases in mobility. In the toner cartridge disclosed in JP-A 2006-235255, when the mobility of toner decreases, the toner is not easily discharged through the discharge port and becomes caught between the discharge member and the inner wall surface of the discharge container and compressed. When the toner is compressed, the torque necessary for rotating the discharge member at a constant rotation speed (hereinafter referred to as “driving torque”) increases. Thus, the driving torque becomes larger than the torque which a driving portion such as a motor connected to the discharge member applies to the discharge member. As a result, a locking phenomenon where the rotation of the discharge member stops occurs.

In the discharger disclosed in JP-A 2008-32769, since two spiral blades are configured so as to convey toner in opposite directions, toner is caught between the two spiral blades and compressed. Therefore, like the toner cartridge disclosed in JP-A 2006-235255, the driving torque increases, and the locking phenomenon occurs.

### SUMMARY OF THE TECHNOLOGY

The technology has been made to solve the above-described problem and an object thereof is to provide a toner discharging device, a toner cartridge, and an image forming apparatus in which occurrence of the locking phenomenon can be suppressed.

The technology provides a toner discharging device comprising:

a discharge container comprising a wall portion which defines an internal space thereof and has a reception port for receiving toner and a discharge port for discharging toner; and

a discharge member provided in the discharge container, the discharge member including:
a rotation shaft, and
a discharge blade provided around the rotation shaft, the discharge blade moving, according to rotation motion following rotation of the rotation shaft, the toner in the discharge container in a discharge direction that is an axial line direction of the rotation shaft that goes from the reception port to the discharge port, the discharge blade being a decay spiral blade whose lead angle of an outer circumferential portion thereof becomes smaller as advancing in the discharge direction,

at least a part of the wall portion of the discharge container surrounding the decay spiral blade along the axial line direction of the rotation shaft, and the discharge port being formed on the part of the wall portion.

The discharge blade moving toner in the discharge container is a decay spiral blade. Since a lead angle of the outer circumferential portion of the decay spiral blade becomes smaller as advancing in the discharge direction, and a toner conveying speed thus slows as advancing in the discharge direction, with the result that the toner becomes difficult to be rapidly compressed, and is easily discharged from the discharge port. Therefore, the occurrence of the locking phenomenon can be suppressed.

Further, it is preferable that the decay spiral blade is an annular decay spiral blade whose external diameter is constant, and whose internal diameter continuously becomes larger as advancing in the discharge direction, and

the rotation shaft is a truncated-cone-shaped rotation shaft whose external diameter continuously becomes larger as advancing in the discharge direction.

The rotation shaft is the truncated-cone-shaped rotation shaft whose external diameter continuously becomes larger as advancing in the discharge direction. Accordingly, toner conveyed by the discharge blade is biased in a direction that separates from an axial line of the rotation shaft. The discharge port is provided at the wall portion surrounding the rotation shaft along the axial line direction of the rotation shaft, and the toner moves in the direction that separates from the axial line of the rotation shaft, that is, a direction that comes close to the discharge port. Therefore, it is possible to discharge the toner easily from the discharge port. Furthermore, the discharge blade is the annular decay spiral blade whose external diameter is constant, and whose internal diameter continuously becomes larger as advancing in the discharge direction. Accordingly, it is possible to make a clearance between the discharge blade and the rotation shaft small, and this makes it possible to disperse a load applied to toner.

Further, it is preferable that a surface part of the truncated-cone-shaped rotation shaft is formed of an elastic sponge.

Further, the surface part of the rotation shaft is formed of an elastic sponge. This makes it possible to suppress a load on the toner due to turn of toner flow.

Further, it is preferable that the discharge container has a cylindrical internal space, and is configured so that an axial line direction of the cylindrical internal space is identical to an axial line direction of the truncated-cone-shaped rotation shaft, and

the truncated-cone-shaped rotation shaft is configured so that a maximum value of the external diameter thereof is 0.8 time or more and 0.95 time or less a diameter of the cylindrical internal space.

The rotation shaft has a maximum value of the external diameter thereof that is 0.8 time or more and 0.95 time or less the diameter of the cylindrical internal space of the discharge container. The maximum value of the external diameter of the rotation shaft falls within this range so that space between the rotation shaft and an inner wall surface of the discharge container becomes an appropriate size, and it is thus possible to enhance discharge efficiency of toner.

Further, it is preferable that in the decay spiral blade, a ratio L_{B}/L_{A} between a maximum value L_{A} of the lead of the outer circumferential portion thereof and a minimum value L_{B} of the lead of the outer circumferential portion thereof, is 0.1 or more and 0.3 or less.

The decay spiral blade has the ratio L_{B}/L_{A} of 0.1 or more and 0.3 or less. This makes it possible to discharge toner having good characteristics while suppressing the occurrence of the locking phenomenon.

Further, the technology provides a toner cartridge comprising:

the toner discharging device mentioned above;

a storage container that stores toner;

a conveying container having a conveying port through which the toner is conveyed to the discharge container;

a scooping member which is provided in the storage container so as to scoop up the toner in the storage container into the conveying container; and

a conveying member which is provided in the conveying container so as to convey the toner in the conveying container towards the conveying port,

the discharge container and the conveying container being connected so that the toner in the conveying container can be moved to the discharge container through the conveying port and the reception port.

Since the toner cartridge includes the toner discharging device, the occurrence of the locking phenomenon can be suppressed.

The technology also provides an electrophotographic image forming apparatus comprising a developing device,

the toner cartridge mentioned above being provided as a toner cartridge for supplying toner to the developing device.

Since the image forming apparatus includes the toner cartridge, toner can be stably supplied to the developing device for a long period. Therefore, the image forming apparatus can form images stably for a long period.

### BRIEF DESCRIPTION OF THE DRAWINGS

Other and further objects, features, and advantages will be more explicit from the following detailed description taken with reference to the drawings wherein:

FIG. 1 is a schematic diagram showing a configuration of an image forming apparatus;

FIG. 2 is a perspective view showing a toner cartridge unit;

FIG. 3 is a schematic view showing an inner configuration of a toner cartridge;

FIG. 4 is a sectional view of the toner cartridge taken along the line A-A of FIG. 3;

FIG. 5 is an end view of the toner cartridge taken along the line B-B of FIG. 4;

FIGS. 6A to 6C are diagrams illustrating one cyclic common spiral blade surface;

FIG. 7 is a schematic view showing an inner configuration of the toner discharging device;

FIGS. 8A to 8C are diagrams illustrating two cyclic decay spiral blade surfaces;

FIG. 9 is a schematic view showing an inner configuration of a toner cartridge;

FIG. 10 is an end view of the toner cartridge;

FIG. 11 is a schematic view showing an inner configuration of a toner discharging device;

FIG. 12A is a diagram showing a discharge blade;

FIG. 12B is a diagram showing a rotation shaft;

FIGS. 13A to 13C are diagrams showing examples of a truncated-cone-shaped rotation shaft;

FIGS. 14A to 14D are diagrams illustrating two cyclic annular decay spiral blade surfaces;

FIG. 15 is a diagram showing a rectangle t₅ corresponding to a side surface of an imaginary circular column K₅ at the time of developing the imaginary circular column K₅; and

FIG. 16 is an end view of a discharge member cut along an end face line running through an axial line of the rotation shaft.

### DETAILED DESCRIPTION

Now referring to the drawings, preferred embodiments are described below.

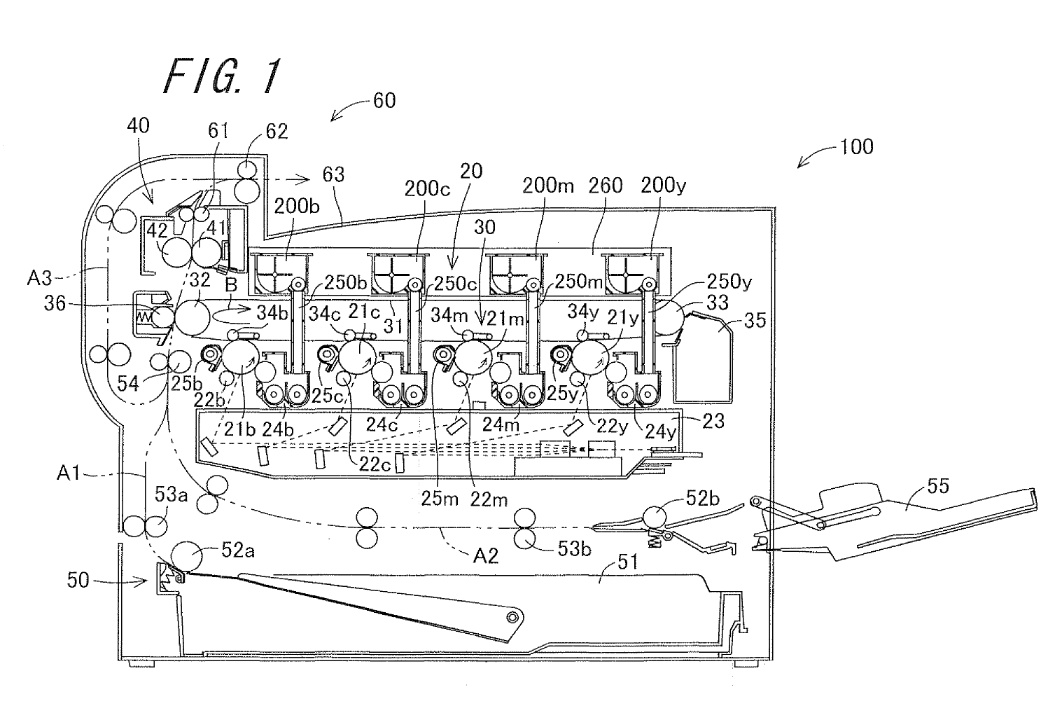

First, an image forming apparatus 100 having a toner cartridge 200 according to a first embodiment will, be described. FIG. 1 is a schematic diagram showing a configuration of the image forming apparatus 100. The image forming apparatus 100 is a multi-functional peripheral which has a copier function, a printer function, and a facsimile function. A full-color or monochrome image is formed on a recording medium in accordance with the image information transmitted to the image forming apparatus 100. The image forming apparatus 100 has three print modes, that is, a copier mode (copying mode), a printer mode, and a facsimile mode. The print mode is selected by a control unit section (not shown) in accordance with the operation input from an operation portion (not shown) and reception of a print job from a personal computer, a mobile terminal device, an information recording medium, or an external device using a memory device.

The image forming apparatus 100 includes a toner image forming section 20, a transfer section 30, a fixing section 40, a recording medium feeding section 50, a discharging section 60, and a control unit section (not shown). The toner image forming section 20 includes photoreceptor drums 21b, 21c, 21m, and 21y, charging sections 22b, 22c, 22m, and 22y, an exposure unit 23, developing devices 24b, 24c, 24m, and 24y, cleaning units 25b, 25c, 25m, and 25y, and toner cartridges 200b, 200c, 200m, and 200y. The toner cartridges 200b, 200c, 200m, and 200y are provided as a toner cartridge unit 260. Description of the toner cartridge unit 260 will be provided later. The transfer section 30 includes an intermediate transfer belt 31, a driving roller 32, a driven roller 33, intermediate transfer rollers 34b, 34c, 34m, and 34y, a transfer belt cleaning unit 35, and a transfer roller 36.

The photoreceptor drum 21, the charging section 22, the developing device 24, the cleaning unit 25, the toner cartridge 200, and the intermediate transfer roller 34 are provided in four sets so as to correspond to the image information of the respective colors of black (b), cyan (c), magenta (m), and yellow (y) which are included in the color image information. In this specification, when the four sets of respective components provided for the respective colors are distinguished, letters indicating the respective colors are affixed to the end of the numbers representing the respective components, and combinations of the numbers and alphabets are used as the reference numerals. When the respective components are collectively referred, only the numerals representing the respective components are used as the reference numerals.

The photoreceptor drum 21 is supported so as to be rotatable around an axial line thereof by a driving section (not shown) and includes a conductive substrate (not shown) and a photoconductive layer (not shown) formed on the surface of the conductive substrate. The conductive substrate can be formed in various shapes such as a cylindrical shape, a circular columnar shape, and a thin-film sheet shape. The photoconductive layer is formed of a material which exhibits conductive properties upon irradiation of light. As for the photoreceptor drum 21, a structure which includes a cylindrical member (conductive substrate) formed of aluminum and a thin film (photoconductive layer) formed on the outer circumferential surface of the cylindrical member and formed of amorphous silicon (a-Si), selenium (Se), or an organic photoconductor (OPC) can be used, for example.

The charging section 22, the developing device 24, and the cleaning unit 25 are disposed around the photoreceptor drum 21 in that order in a rotation direction thereof. The charging section 22 is disposed vertically below the developing device 24 and the cleaning unit 25.

The charging section 22 is a device that charges a surface of the photoreceptor drum 21 so as to have predetermined polarity and potential. The charging section 22 is provided along a longitudinal direction of the photoreceptor drum 21 so as to face the photoreceptor drum 21. In the case of a contact charging type, the charging section 22 is provided in contact with the surface of the photoreceptor drum 21. In the case of a non-contact charging type, the charging section 22 is provided so as to be separated from the surface of the photoreceptor drum 21.

The charging section 22 is provided around the photoreceptor drum 21 together with the developing device 24, the cleaning unit 25, and the like. The charging section 22 is preferably provided at a position closer to the photoreceptor drum 21 than the developing device 24, the cleaning unit 25, and the like. In this way, it is possible to securely prevent the occurrence of charging faults of the photoreceptor drum 21.

As for the charging section 22, a brush-type charger, a roller-type charger, a corona discharger, an ion-generating device, or the like can be used. The brush-type charger and the roller-type charger are a charging device of contact charging type. The brush-type charger includes one which uses a charging brush, one which uses a magnetic brush, and one which uses other brushes. The corona discharger and the ion-generating device are a charging device of non-contact charging type. The corona discharger includes one which uses a wire-shaped discharge electrode, one which uses a pin-array discharge electrode, one which uses a needle-shaped discharge electrode, and one which uses other discharge electrodes.

The exposure unit 23 is disposed so that light emitted from the exposure unit 23 passes between the charging section 22 and the developing device 24 and reaches the surface of the photoreceptor drum 21. In the exposure unit 23, the charged surfaces of the photoreceptor drums 21b, 21c, 21m, and 21y are irradiated with laser beams corresponding to image information of the respective colors, whereby electrostatic latent images corresponding to the image information of the respective colors are formed on the respective surfaces of the photoreceptor drums 21b, 21c, 21m, and 21y. As for the exposure unit 23, a laser scanning unit (LSU) having a laser-emitting portion and a plurality of reflecting mirrors can be used, for example. As for the exposure unit 23, an LED (Light Emitting Diode) array and a unit in which a liquid-crystal shutter and a light source are appropriately combined may be used.

The developing device 24 includes a developer tank and a toner supply pipe 250. The developer tank contains toner in an internal space thereof. In the developer tank, a developing roller and first and second conveying screws are rotatably supported. An opening is formed on a side surface of the developer tank facing the photoreceptor drum 21, and the developing roller is provided at such a position as to face the photoreceptor drum 21 with the opening interposed therebetween.

The developing roller is a member which is disposed closest to the photoreceptor drum 21 so as to supply toner to an electrostatic latent image on the surface of the photoreceptor drum 21. When the toner is supplied, a potential having polarity opposite to the polarity of the potential of the charged toner is applied to a surface of the developing roller as a development bias voltage. In this way, the toner on the surface of the developing roller is smoothly supplied to the electrostatic latent image. The amount of toner supplied to the electrostatic latent image (the amount of which is referred to as “toner attachment amount”) can be controlled by changing the value of the development bias voltage.

The first conveying screw is a member which faces the developing roller and supplies toner to the vicinity of the developing roller. The second conveying screw is a member which faces the first conveying screw and feeds toner which is newly supplied into the developer tank through the toner supply pipe 250 to the vicinity of the first conveying screw.

The toner supply pipe 250 is disposed so as to connect a toner supply port formed in a vertically lower part of the toner supply pipe 250 to a toner reception port formed in a vertically upper part of the developer tank. The toner supply pipe 250 supplies toner supplied from the toner cartridge 200 to the developer tank. As another embodiment, toner may be supplied directly from the toner cartridge 200 of each color to the developer tank without using the toner supply pipe 250.

A toner concentration detection sensor is provided on a bottom surface of the developer tank. The toner concentration detection sensor detects a toner concentration in the developer tank. As for the toner concentration detection sensor, a general toner concentration detection sensor can be used, and examples thereof include a transmission light detection sensor, a reflection light detection sensor, a permittivity detection sensor, and the like. Among these sensors, a permittivity detection sensor is preferred.

The toner concentration detection sensor is electrically connected to a toner concentration control section. The toner concentration control section controls so that a discharge member 320 (described later) in the toner cartridge 200 is rotated and the toner in the toner cartridge 200 is supplied into the developer tank when the toner concentration value detected by the toner concentration detection sensor is determined to be lower than a predetermined setting value.

The cleaning unit 25 is a member which removes the toner which remains on the surface of the photoreceptor drum 21 after the toner image has been transferred from the photoreceptor drum 21 to the intermediate transfer belt 31, and thus cleans the surface of the photoreceptor drum 21. As for the cleaning unit 25, a plate-shaped member for scraping toner and a container-like member for collecting the scraped toner are used, for example.

According to the toner image forming section 20, the surface of the photoreceptor drum 21 which is evenly charged by the charging section 22 is irradiated with laser beams corresponding to the image information from the exposure unit 23, whereby electrostatic latent images are formed on the surface of the photoreceptor drum 21. The toner is supplied from the developing device 24 to the electrostatic latent images on the photoreceptor drum 21, whereby toner images are formed. The toner images are transferred to the intermediate transfer belt 31 described later. The toner which remains on the surface of the photoreceptor drum 21 after the toner images has been transferred to the intermediate transfer belt 31 is removed by the cleaning unit 25.

The intermediate transfer belt 31 is an endless belt-shaped member which is disposed vertically above the photoreceptor drum 21. The intermediate transfer belt 31 is supported around the driving roller 32 and the driven roller 33 with tension to form a loop-shaped path and is turned to run in the direction indicated by an arrow B.

The driving roller 32 is provided so as to be rotatable around an axial line thereof by a driving section (not shown). The intermediate transfer belt 31 is caused to turn by rotation of the driving roller 32 in the direction indicated by the arrow B. The driven roller 33 is provided so as to be rotatable in accordance with rotation of the driving roller 32 and generates a constant tension in the intermediate transfer belt 31 so that the intermediate transfer belt 31 does not go slack.

The intermediate transfer roller 34 is provided so as to come into pressure-contact with the photoreceptor drum 21 with the intermediate transfer belt 31 interposed therebetween and be rotatable around an axial line thereof by a driving section (not shown). As for the intermediate transfer roller 34, one in which a conductive elastic member is formed on the surface of a roller made of metal (for example, stainless steel) having a diameter of 8 mm to 10 mm can be used for example. The intermediate transfer roller 34 is connected to a power source (not shown) that applies a transfer bias voltage and has a function of transferring the toner images on the surface of the photoreceptor drum 21 to the intermediate transfer belt 31.

The transfer roller 36 is provided so as to come into pressure-contact with the driving roller 32 with the intermediate transfer belt 31 interposed therebetween and be rotatable around an axial line thereof by a driving section (not shown). In a pressure-contact portion (a transfer nip region) between the transfer roller 36 and the driving roller 32, the toner images which have been borne on the intermediate transfer belt 31 and conveyed to the pressure-contact portion are transferred to a recording medium fed from the recording medium feeding section 50 described later.

The transfer belt cleaning unit 35 is provided so as to face the driven roller 33 with the intermediate transfer belt 31 interposed therebetween and come into contact with a toner image bearing surface of the intermediate transfer belt 31. The transfer belt cleaning unit 35 is provided so as to remove and collect the toner which remains on the surface of the intermediate transfer belt 31 after the toner images have been transferred to the recording medium. When the toner remains adhering to the intermediate transfer belt 31 after the toner images have been transferred to the recording medium, there is a possibility that the residual toner adheres to the transfer roller 36 due to turning of the intermediate transfer belt 31. When the toner adheres to the transfer roller 36, the toner may contaminate the rear surface of a recording medium which is subsequently subjected to transfer.

According to the transfer section 30, when the intermediate transfer belt 31 is turned to run while making contact with the photoreceptor drum 21, a transfer bias voltage having a polarity opposite to the polarity of the charged toner on the surface of the photoreceptor drum 21 is applied to the intermediate transfer roller 34, and the toner images formed on the surface of the photoreceptor drum 21 are transferred to the intermediate transfer belt 31. The toner images of the respective colors formed by the respective photoreceptor drums 21y, 21m, 21c, and 21b are sequentially transferred and overlaid onto the intermediate transfer belt 31, whereby full-color toner images are formed. The toner images transferred to the intermediate transfer belt 31 are conveyed to the transfer nip region by turning movement of the intermediate transfer belt 31, and the toner images are transferred to the recording medium in the transfer nip region. The recording medium on which the toner images are transferred is conveyed to a fixing section 40 described later.

The recording medium feeding section 50 includes a paper feed box 51, pickup rollers 52a and 52b, conveying rollers 53a and 53b, registration rollers 54, and a paper feed tray 55. The paper feed box 51 is a container-shaped member which is disposed in a vertically lower part of the image forming apparatus 100 so as to store recording mediums at the inside of the image forming apparatus 100. The paper feed tray 55 is a tray-shaped member which is provided on an outer wall surface of the image forming apparatus 100 so as to store recording mediums outside the image forming apparatus 100. Examples of the recording medium include plain paper, color copy paper, overhead projector sheets, and postcards.

The pickup roller 52a is a member which takes out the recording mediums stored in the paper feed box 51 sheet by sheet and feeds the recording medium to a paper conveyance path A1. The conveying rollers 53a are a pair of roller-shaped members disposed so as to come into pressure-contact with each other, and convey the recording medium towards the registration rollers 54 along the paper conveyance path A1. The pickup roller 52b is a member which takes out the recording mediums stored in the paper feed tray 55 sheet by sheet and feeds the recording medium to a paper conveyance path A2. The conveying rollers 53b are a pair of roller-shaped members disposed so as to come into pressure-contact with each other, and convey the recording medium towards the registration roller 54 along the paper conveyance path A2.

The registration rollers 54 are a pair of roller-shaped members disposed so as to come into pressure-contact with each other, and feed the recording medium fed from the conveying rollers 53a and 53b to the transfer nip region in synchronization with the conveyance of the toner images borne on the intermediate transfer belt 31 to the transfer nip region.

According to the recording medium feeding section 50, the recording medium is fed from the paper feed box 51 or the paper feed tray 55 to the transfer nip region in synchronization with the conveyance of the toner images borne on the intermediate transfer belt 31 to the transfer nip region, and the toner images are transferred to the recording medium.

The fixing section 40 includes a heating roller 41 and a pressure roller 42. The heating roller 41 is controlled so as to maintain a predetermined fixing temperature. The pressure roller 42 is a roller that comes into pressure-contact with the heating roller 41. The heating roller 41 and the pressure roller 42 pinch the recording medium under application of heat, thus fusing the toner of the toner images so as to be fixed to the recording medium. The recording medium to which the toner images have been fixed is conveyed to the discharging section 60 described later.

The discharging section 60 includes conveying rollers 61, discharge rollers 62, and a discharge tray 63. The conveying rollers 61 are a pair of roller-shaped members which is disposed vertically above the fixing section 40 so as to come into pressure-contact with each other. The conveying rollers 61 convey the recording medium on which images have been fixed towards the discharge rollers 62.

The discharge rollers 62 are a pair of roller-shaped members which is disposed so as to come into contact with each other. In the case of single-side printing, the discharge rollers 62 discharge a recording medium on which single-side printing has finished to the discharge tray 63. In the case of double-side printing, the discharge rollers 62 convey a recording medium on which single-side printing has finished to the registration rollers 54 along the paper conveyance path A3 and then discharges a recording medium on which double-side printing has finished to the discharge tray 63. The discharge tray 63 is provided on the vertically upper surface of the image forming apparatus 100 so as to store recording mediums to which images have been fixed.

The image forming apparatus 100 includes the control unit section (not shown). The control unit section is provided in the vertically upper part of the internal space of the image forming apparatus 100 and includes a memory portion, a computing portion, and a control portion. To the memory portion, various setting values mediated through an operation panel (not shown) disposed on the vertically upper surface of the image forming apparatus 100, the results detected by sensors (not shown) disposed in various portions inside the image forming apparatus 100, image information from an external device and the like are inputted. Moreover, programs for executing various processes are written in the memory portion. Examples of the various processes include a recording medium determination process, an attachment amount control process, and a fixing condition control process.

As for the memory portion, memories customarily used in this technical field can be used, and examples thereof include a read-only memory (ROM), a random-access memory (RAM), and a hard disc drive (HDD). As for the external device, electrical and electronic devices which can form or obtain the image information and which can be electrically connected to the image forming apparatus 100 can be used. Examples thereof include computers, digital cameras, televisions, video recorders, DVD (Digital Versatile Disc) recorders, HDDVD (High-Definition Digital Versatile Disc) recorders, Blu-ray disc recorders, facsimile machines, and mobile terminal devices.

The computing portion takes out various kinds of data (for example, image formation commands, detection results, and image information) written in the memory portion and the programs for various processes and then makes various determinations. The control portion sends a control signal to the respective devices provided in the image forming apparatus 100 in accordance with the determination result by the computing portion, thus performing control on operations.

The control portion and the computing portion include a processing circuit which is realized by a microcomputer, a microprocessor, and the like having a central processing unit (CPU). The control unit section includes a main power source as well as the processing circuit. The power source supplies electricity to not only the control unit section but also to respective devices provided in the image forming apparatus 100.

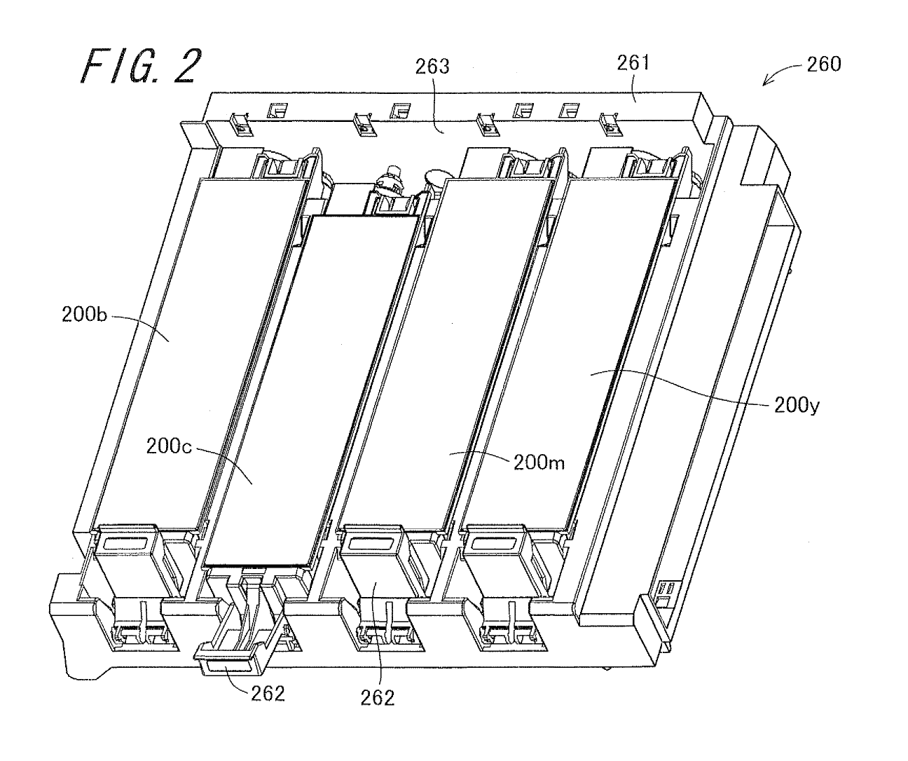

Next, the toner cartridge unit 260 will be described. FIG. 2 is a perspective view showing the toner cartridge unit 260. The toner cartridge unit 260 includes the toner cartridges 200b, 200c, 200m, and 200y and a toner cartridge mount 261. The toner cartridge mount 261 includes a locking lever 262 configured to be angularly displaceable and a stopper plate 263. Each toner cartridge 200 is fixed to the toner cartridge mount 261 when the locking lever 262 is angularly displaced towards the stopper plate 263 in a state of being mounted on the toner cartridge mount 261.

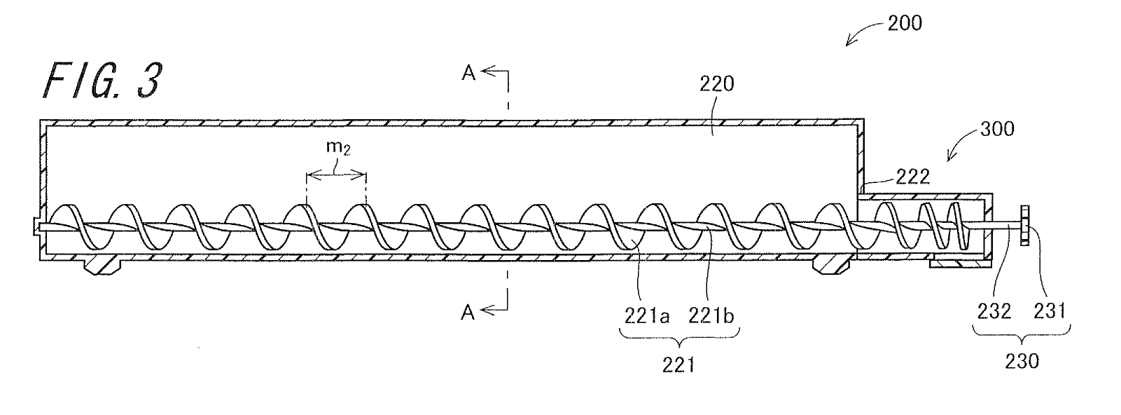

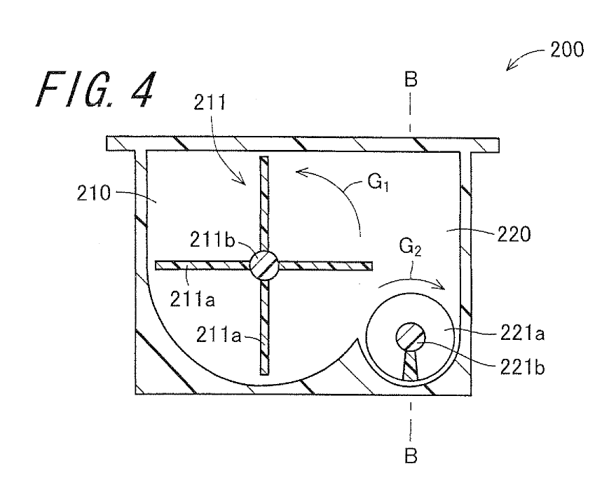

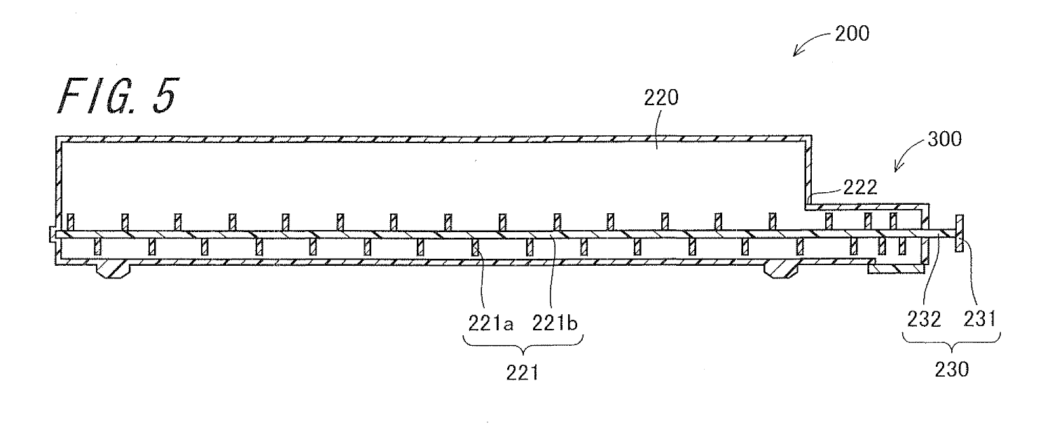

FIG. 3 is a schematic view showing a configuration of an inside of the toner cartridge 200. FIG. 4 is a sectional view of the toner cartridge 200 taken along the line A-A of FIG. 3. FIG. 5 is an end view of the toner cartridge 200 taken along the line B-B of FIG. 4. The toner cartridge 200 includes a toner discharging device 300, a storage container 210, a conveying container 220, a scooping member 211, a conveying member 221, and a transmission member 230 and supplies toner to the developing device 24.

The storage container 210 is a container-shaped member which has an internal space having an approximately semicircular columnar shape, and toner is contained in the internal space, and the scooping member 211 is provided therein. The scooping member 211 is a member which scoops up the toner in the storage container 210 by rotation thereof, thus supplying the toner to the conveying container 220. The scooping member 211 includes four scooping plates 211a and a rotation shaft 211b. The rotation shaft 211b is a circular columnar member. The scooping plates 211a are formed on the rotation shaft 211b along the axial line direction of the rotation shaft 211b. The scooping member 211 is connected to a driving section (not shown), and the rotation shaft 211b rotates in a rotation direction G₁ around an axial line thereof by the torque applied from the driving section. When the scooping plates 211a rotationally moves around the axial line of the rotation shaft 211b following rotation of the rotation shaft 211b, the toner in the storage container 210 is scooped up.

The conveying container 220 is a container-shaped member which has an internal space having an approximately semicircular columnar shape, and the internal space thereof communicates with the internal space of the storage container 210. A conveying port 222 is formed on a wall portion of the conveying container 220, and the conveying port 222 is an opening through which the toner supplied by the scooping plates 211a is conveyed to the toner discharging device 300. Moreover, the conveying member 221 is provided in the conveying container 220. The conveying member 221 includes a conveying blade 221a and a conveying shaft 221b. The conveying member 221 is a member which conveys the toner in the conveying container 220 towards the conveying port 222 when the conveying shaft 221b rotates in a rotation direction G₂ around an axial line thereof.

The conveying shaft 221b is a circular columnar member having an external diameter of 3 mm to 10 mm. The conveying shaft 221b is formed of a material, for example, such as polyethylene, polypropylene, high-impact polystyrene, or ABS resin (acrylonitrile-butadiene-styrene copolymer synthetic resin).

The conveying blade 221a is provided around the conveying shaft 221b. The conveying blade 221a is formed of a material, for example, such as polyethylene, polypropylene, high-impact polystyrene, or ABS resin. The conveying blade 221a rotates following rotation of the conveying shaft 221b, thus conveying the toner in the conveying container 220 towards the conveying port 222.

In this embodiment, a conveying blade 221a is a continuous common spiral blade. In this embodiment, the “common spiral blade” is schematically a blade part of a so-called auger screw, and more specifically, is a member with a predetermined thickness having a common spiral blade surface as a main surface. The common spiral blade is provided around the conveying shaft 221b in an inner circumferential portion thereof. Here, the inner circumferential portion of the common spiral blade is a part that comes closest to an axial line of the conveying shaft 221b on the common spiral blade surface, and an outer circumferential portion of the common spiral blade is a part that is farthest from the conveying shaft 221b on the common spiral blade surface. A shape of the common spiral blade surface is a shape in which the inner circumferential portion and the outer circumferential portion are imaginary common spirals that are different from each other, and the details will be described below.

In this embodiment, a “spiral” is a consecutive space curve on a side surface of an imaginary circular column, and a space curve that advances in one direction of axial line directions of the imaginary circular column while advancing in one direction of circumferential directions of the imaginary circular column. Out of the spirals, a spiral whose lead angle is constant in all points on the spiral is especially referred to as a “common spiral”. Here, an angle formed of a tangent line of the spiral at a certain point on the spiral and a straight line that is made by projecting the tangent line to a vertical plane with respect to an axial line direction of the imaginary circular column surrounded by the spiral is a “lead angle” at the point. The lead angle is an angle that is larger than 0° and smaller than 90°.

An interval of the spiral in the axial line direction of the imaginary circular column is referred to as a “lead”. In a one-cyclic or more common spiral, since a lead angle is constant, a lead is also constant. Hereinafter, a lead of an outer circumferential portion of a common spiral blade surface that is a main surface of a common spiral blade is referred to as a lead of the outer circumferential portion of the common spiral blade.

In this embodiment, the “common spiral blade surface” is a surface formed by the trajectory of one line segment L₁ outside an imaginary circular column K₁ (hereinafter a radius is r₁) when the line segment L₁ is moved in one direction D₁ parallel to the axial line of the imaginary circular column K₁ while maintaining a length m₁ of the line segment L₁ in a radial direction of the imaginary circular column K₁ and an attachment angle α of the line segment L₁ along one spiral C₁ (lead angle: θ₁) on a side surface of the imaginary circular column K₁. Here, the “attachment angle α” is an angle formed by the line segment L₁ and a half-line extending in the one direction D₁ from a tangent point of the line segment L₁ and the imaginary circular column K₁ on a plane including the axial line of the imaginary circular column K₁ and the line segment L₁. The attachment angle α is an angle that is larger than 0° and smaller than 180°.

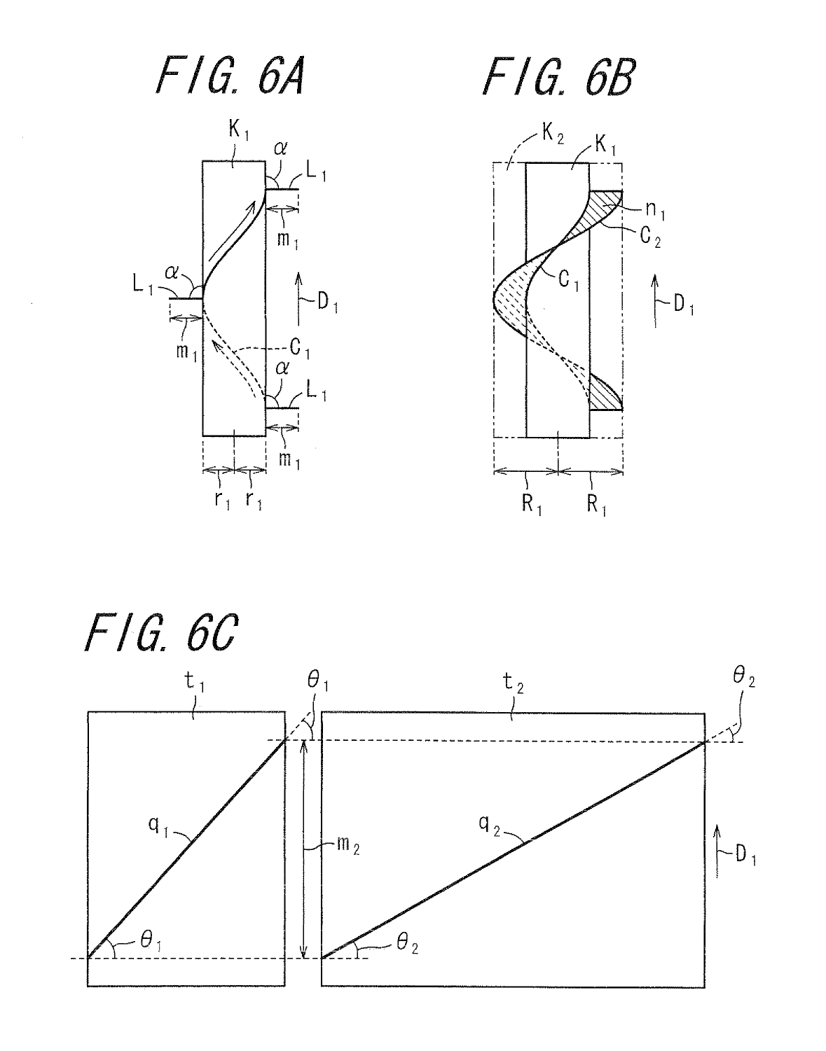

Hereinafter, as an example of the common spiral blade surface, a common spiral blade surface obtained when a line segment is moved along a one cyclic portion of a common spiral (“one cyclic common spiral blade surface”; the same applies to other cycles) is illustrated. FIGS. 6A to 6C are diagrams illustrating the one cyclic common spiral blade surface. FIG. 6A shows a side surface of the imaginary circular column K₁, a common spiral C₁ on the side surface of the imaginary circular column K₁ and starting and end positions of the line segment L₁ moving in the one direction D₁ on the common spiral C₁. The line segment L₁ shown on the lowermost side of the sheet surface of FIG. 6A indicates the starting position in moving, and the line segment L₁ shown on the uppermost side indicates the end position. As shown in FIG. 6A, the trajectory of the line segment L₁ when the line segment L₁ is moved in the one direction D₁ along the common spiral C₁ while constantly maintaining the length m₁ in the radial direction of the imaginary circular column K₁ and the attachment angle α (α=90° in FIG. 6A) of the line segment L₁ corresponds to a common spiral blade surface n₁ shown in FIG. 6B. A surface depicted by a hatched portion in FIG. 6B is the common spiral blade surface n₁.

As shown in FIG. 6B, an outer circumferential portion of the common spiral blade surface n₁ becomes a common spiral C₂ (a lead angle is constant at θ₂) that advances in the one direction D₁ on a side surface of an imaginary circular column K₂ whose axial line is identical to that of the imaginary circular column K₁. A radius R₁ of the imaginary circular column K₂ is equal to the sum of a radius r₁ of the imaginary circular column K₁ and the length m₁ of the line segment L₁ in the radial direction of the imaginary circular column K₁.

A rectangle t₁ corresponding to the side surface of the imaginary circular column K₁ at the time of developing the imaginary circular column K₁ and a rectangle t₂ corresponding to the side surface of the imaginary circular column K₂ at the time of developing the imaginary circular column K₂ are shown in FIG. 6C. As shown in FIG. 6C, lines corresponding to the common spirals C₁ and C₂ become straight lines q₁ and q₂ obliquely extending in respective rectangles t₁ and t₂ The lead angle θ₁ becomes an angle of a slope of the straight line q₁, and the lead angle θ₂ becomes an angle of a slope of the straight line q₂.

A member with such a common spiral blade surface as a main surface is a common spiral blade. The above-described common spiral blade is, in the case of being used as the conveying blade 221a as in this embodiment, configured so that a diameter 2r₁ of the imaginary circular column K₁ is equal to an external diameter of the conveying shaft 221b. Then, the common spiral blade is provided so that the common spiral blade surface n₁ is placed on a side of a conveying port 222 in an axial line direction of the conveying shaft 221b, and is provided so as to convey toner towards the conveying port 222 with the common spiral blade surface n₁.

At the time, a value twice a distance between an inner circumferential portion of the common spiral blade and an axial line of the conveying shaft 221b, that is, an internal diameter of the common spiral blade becomes 2r₁, and a value twice a distance between an outer circumferential portion of the common spiral blade and the axial line of the conveying shaft 221b, that is, an external diameter of the common spiral blade becomes 2r₁+2m₁. The length m₁ can be appropriately set, for example, within a range of 2 mm to 20 mm. Moreover, for example, the attachment angle α does not need to be 90°, and can be appropriately set within a range of 30° to 150°. The lead angle θ₁ can be appropriately set, for example, within a range of 20° to 70°, and the lead angle θ₂ can be appropriately set, for example, within a range of 0° to 60°. Additionally, a lead m₂ of the outer circumferential portion of the common spiral blade can be appropriately set, for example, within a range of 10 mm to 30 mm.

In this embodiment, the conveying blade 221a is a common spiral blade having 14 cyclic common spiral blade surfaces, and the thickness of the common spiral blade is uniformly 1.5 mm. The cycle, the thickness and the like of the common spiral blade can be appropriately set in accordance with a toner conveying speed, the size of the toner cartridge 200, and the like. For example, the thickness of the common spiral blade used as the conveying blade 221a can be appropriately set within the range of 1 mm to 3 mm.

Note that, in this embodiment, although the conveying blade 221a is a continuous common spiral blade, as another embodiment, the conveying blade 221a may be a plurality of common spiral blades that separate from each other at a predetermined interval.

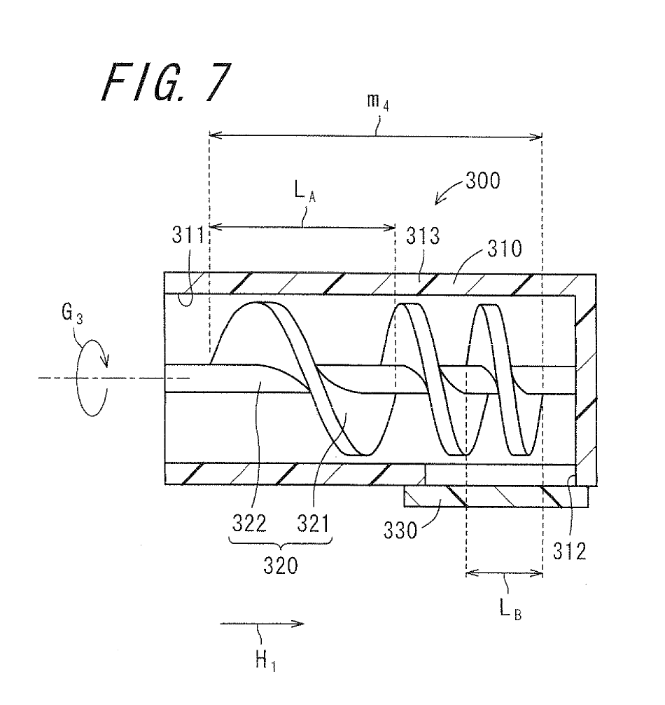

FIG. 7 is a schematic view showing an inner configuration of the toner discharging device 300. The toner discharging device 300 includes a discharge container 310, a discharge member 320 and a shutter member 330. The discharge container 310 is a container-shaped member which has a cylindrical internal space, and comprises a wall portion 313 which defines the internal space and has a reception port 311 for receiving toner which is an opening. The discharge container 310 and the conveying container 220 are connected so that the toner in the conveying container 220 can move into the discharge container 310 through the conveying port 222 and the reception port 311. That is, the internal space of the conveying container 220 and the internal space of the discharge container 310 communicate with each other. The discharge container 310 and the conveying container 220 may be configured as an integral member and may be configured to be detachable.

Additionally, as to discharge container 313, of the wall portion 313 of the discharge container 310, at least a part of the wall portion 313 surrounding the discharge member 320 (a discharge blade 321 and a rotation shaft 322) along an axial line direction of the discharge member 320 has a discharge port 312 which is an opening for discharging toner. In this embodiment, the discharge port 312 opens in the wall portion 313 facing the vertically lower part of the discharge container 310. In this embodiment, the discharge port 312 is formed in an approximately rectangular shape. The shutter member 330 is provided so as to be slidable on the vertically lower part of the discharge port 312. The shutter member 330 slides in an approximately horizontal direction by coming into contact with the toner supply pipe 250 in a process where the toner cartridge 200 is mounted on a toner cartridge placement table 261, and the discharge port 312 is thereby opened.

The discharge member 320 is a member which is provided in the discharge container 310 so as to discharge the toner entering from the reception port 311 into the discharge container 310 through the discharge port 312. The toner discharged from the discharge port 312 is supplied to the developing device 24 through the toner supply pipe 250.

The discharge member 320 includes a rotation shaft 322 and a discharge blade 321. The rotation shaft 322 is a circular columnar member having an external diameter of 3 mm to 10 mm, and is provided so that the axial line thereof is identical to the axial line of the discharge container 310. The rotation shaft 322 has one end connected to the conveying shaft 221b and the other end connected to the transmission member 230. The rotation shaft 322, the conveying shaft 221b, and the transmission member 230 may be configured as an integral member and may be configured to be detachable. In this embodiment, the external diameter of the rotation shaft 322 is the same as the external diameter of the conveying shaft 221b, and both axial lines are identical to each other. Note that, the discharge blade 321 on the rotation shaft 322 may continue smoothly into the conveying blade 221a on the conveying shaft 221b, or separate from each other.

The discharge blade 321 is a member which rotates around the axial line of the rotation shaft 322 following rotation of the rotation shaft 322 in a rotation direction G₃ around an axial line thereof, thus moving the toner in the discharge container 310. Description of the discharge blade 321 will be provided later.

The transmission member 230 includes a gear 231 and a transmission shaft 232. The transmission shaft 232 is a circular columnar member of which one end is connected to the gear 231 and the other end is connected to the rotation shaft 322. The gear 231 is a member which transmits the torque applied from a driving section (not shown) such as a motor to the transmission shaft 232. The transmission member 230 rotates at a speed of 30 rpm to 60 rpm in the rotation direction around the axial line of the transmission shaft 232 by the torque applied from a driving section (not shown).

According to the toner cartridge 200, the toner in the storage container 210 is scooped up into the conveying container 220 by the scooping member 211. Moreover, the transmission shaft 232, the rotation shaft 322, and the conveying shaft 221b are integrally rotated by the torque applied from a driving section (not shown). By the rotation of the conveying shaft 221b, the toner in the conveying container 220 is conveyed into the discharge container 310 through the conveying port 222 and the reception port 311. By the rotation of the rotation shaft 322, the toner in the discharge container 310 is discharged from the discharge port 312 and supplied into the developer tank of the developing device 24.

Next, the discharge blade 321 will be described. As shown in FIG. 7, the discharge blade 321 is provided around the rotation shaft 322. The discharge blade 321 rotates around the axial line of the rotation shaft 322 following the rotation of the rotation shaft 322 in the rotation direction G₃. By the rotation, the discharge blade 321 conveys toner in the discharge container 310 in a direction H₁ directed from the reception port 311 to the discharge port 312, of the axial line direction of the rotation shaft 322.

The discharge blade 321 is formed of a material, for example, such as polyethylene, polypropylene, high-impact polystyrene, or ABS resin. In this embodiment, the discharge blade 321 is a continuous decay spiral blade. The decay spiral blade is provided around the rotation shaft 322 in an inner circumferential portion thereof.

In this embodiment, the “decay spiral blade” is schematically a member in which a lead of an outer circumferential portion of a common spiral blade is changed, and more specifically, a member with a predetermined thickness having a decay spiral blade surface as a main surface. Here, the inner circumferential portion of the decay spiral blade is a closest part to the axial line of the rotation shaft 322 of the above-described decay spiral blade surface, and the outer circumferential portion of the decay spiral blade is a farthest part from the rotation shaft 322 of the above-described decay spiral blade surface. A shape of the decay spiral blade surface is a shape in which the inner circumferential portion and the outer circumferential portion thereof are imaginary decay spirals that are different from each other, which will be described in detail below.

In this embodiment, the “decay spiral” is a special spiral, and a spiral whose lead angle becomes smaller as advancing in an axial line direction (discharge direction H₁ in this embodiment) of an imaginary circular column surrounded by the spiral. In the decay spiral, a lead also becomes smaller as advancing in the discharge direction H₁. Hereinafter, a lead of the outer circumferential portion of the decay spiral blade surface that is the main surface of the decay spiral blade is referred to as a lead of the outer circumferential portion the decay spiral blade.

In this embodiment, the “decay spiral blade surface” is a surface formed by the trajectory of one line segment L₂ outside an imaginary circular column K₃ (hereinafter, a radius is r₂) when the line segment L₂ is moved in one direction D₂ parallel to an axial line of the imaginary circular column K₃ while maintaining a length m₃ of the line segment L₂ in the radial direction of the imaginary circular column K₃ and an attachment angle β of the line segment L₂ along one decay spiral C₃ (hereinafter, a lead angle continuously becomes smaller from θ₃ to θ₄) on the side surface of the imaginary circular column K₃. Here, the “attachment angle β” is an angle formed by the line segment L₂ and a half-line extending in the one direction D₂ from a tangent point of the line segment L₂ and the imaginary circular column K₃ on a plane including the axial line of the imaginary circular column K₃ and the line segment L₂, and is an angle that is larger than 0° and smaller than 180°.

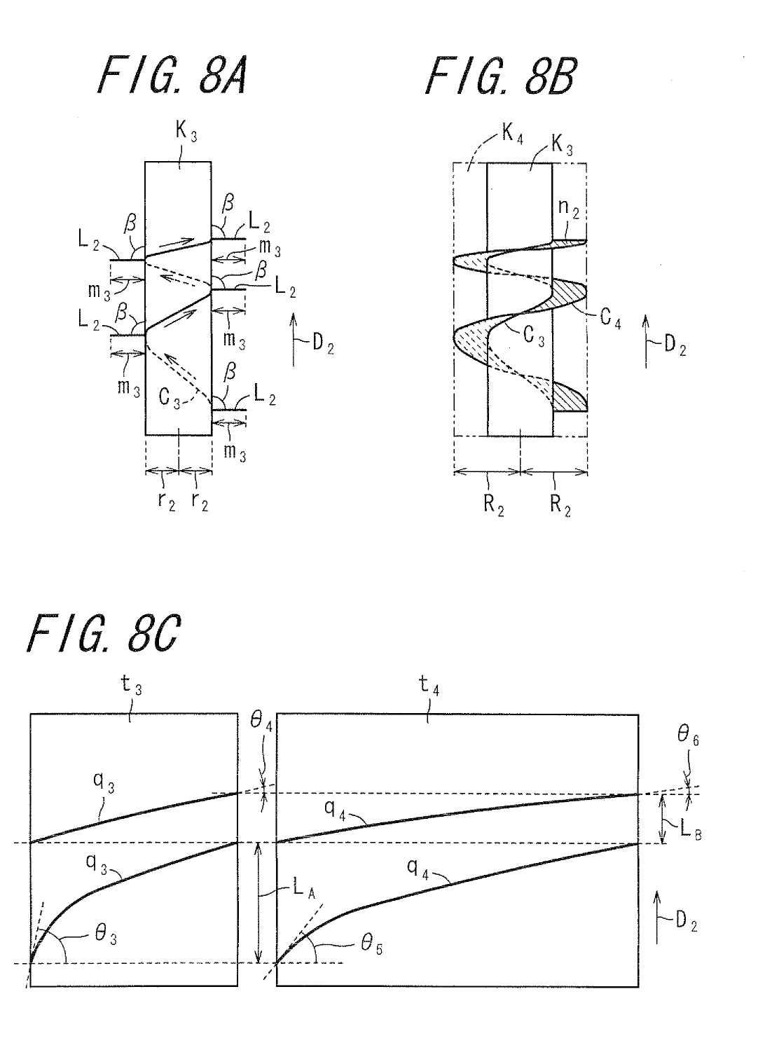

Hereinafter, as an example of the decay spiral blade surface, a decay spiral blade surface obtained when a line segment is moved along a two cyclic portion of a decay spiral (“two cyclic decay spiral blade surfaces”; the same applies to the other cycles) is illustrated. FIGS. 8A to 8C are diagrams illustrating two cyclic decay spiral blade surfaces. FIG. 8A shows the side surface of the imaginary circular column K₃, the decay spiral C₃ on the side surface of the imaginary circular column K₃ and starting and end positions of the line segment L₂ moving in the one direction D₂ on the decay spiral C₃. The line segment L₂ shown on the lowermost side of the sheet surface of FIG. 8A indicates the starting position in moving, and the line segment L₂ shown on the uppermost side indicates the end position. As shown in FIG. 8A, the trajectory of the line segment L₂ when the line segment L₂ is moved in the one direction D₂ along the decay spiral C₃ while constantly maintaining the length m₃ of the line segment L₂ in the radial direction of the imaginary circular column K₃ and the attachment angle β (β=90° in FIG. 8A) of the line segment L₂ corresponds to a decay spiral blade surface n₂ shown in FIG. 8B. A surface depicted by a hatched portion in FIG. 8B is the decay spiral blade surface n₂.

As shown in FIG. 8B, an outer circumferential portion of the decay spiral blade surface n₂ becomes a decay spiral C₄ (where a lead angle continuously becomes smaller from θ₅ to θ₆) that advances in the one direction D₂ on the side surface of an imaginary circular column K₄ whose axial line is identical to that of the imaginary circular column K₃. A radius R₂ of the imaginary circular column K₄ is equal to the sum of the radius r₂ of the imaginary circular column K₃ and the length m₃ of the line segment L₂ in the radial direction of the imaginary circular column K₃.

A rectangle t₃ corresponding to a side surface of the imaginary circular column K₃ at the time of developing the imaginary circular column K₃ and a rectangle t₄ corresponding to a side surface of the imaginary circular column K₄ at the time of developing the imaginary circular column K₄ are shown in FIG. 8C. As shown in FIG. 8C, lines corresponding to the decay spirals C₃ and C₄ become smooth curve lines q₃ and q₄ obliquely extending in respective rectangles t₃ and t₄. The lead angle θ₃ becomes an angle of an initial slope of the curve line q₃, and the lead angle θ₄ becomes an angle of a last slope of the curve line q₃. Further, a lead angle θ₅ becomes an angle of an initial slope of the curve line q₄, and a lead angle θ₆ becomes an angle of a last slope of the curve line q₄. Moreover, a maximum value L_{A} of a lead of the decay spiral C₄ becomes an initial interval of the curve line q₄ in the one direction D₂, and a minimum value L_{B} of the lead of the decay spiral C₄ becomes a last interval of the curve line q₄ in the one direction D₂.

A member with such a decay spiral blade surface as a main surface is a decay spiral blade. The above-described decay spiral blade is, in the case of being used as the discharge blade 321 as in this embodiment, configured so that a diameter 2r₂ of the imaginary circular column K₃ is equal to an external diameter of the rotation shaft 322. Then, the decay spiral blade is provided so that the decay spiral blade surface n₂ is placed on a side of the discharge port 312 in an axial line direction of the rotation shaft 322, and is provided so as to convey toner in a discharge direction H₁ with the decay spiral blade surface n₂.

At the time, a value twice an internal diameter of the decay spiral blade, that is, a distance between the inner circumferential portion of the decay spiral blade and the axial line of the rotation shaft 322 becomes 2r₂, and a value twice an external diameter of the decay spiral blade, that is, a distance between the outer circumferential portion of the decay spiral blade and the axial line of the rotation shaft 322 becomes 2r₂+2m₃. The length m₃ can be appropriately set, for example, within a range of 2 mm to 20 mm. Additionally, an entire length m₄ of the discharge blade 321 (decay spiral blade) in the axial line direction of the rotation shaft 322 can be appropriately set, for example, within a range of 15 mm to 50 mm.

Further, for example, the attachment angle β does not need to be 90°, and can be appropriately set in a range of 30° to 150°. The initial lead angle θ₃ of the inner circumferential portion of the decay spiral blade can be appropriately set, for example, in a range of 20° to 70°, and the last lead angle θ₄ of the inner circumferential portion can be appropriately set, for example, in a range of 0° to 60°. Additionally, the initial lead angle θ₅ of the outer circumferential portion of the decay spiral blade can be appropriately set, for example, in a range of 0° to 60°, and the last lead angle θ₆ of the outer circumferential portion can be appropriately set, for example, in a range of 0° to 50°. In this embodiment, the initial lead angle θ₅ of the outer circumferential portion of the decay spiral blade is the same as the lead angle θ₂ of the outer circumferential portion of the conveying blade 221a. Note that, the lead angle θ₅ may be set smaller than the lead angle θ₂.

In this embodiment, the discharge blade 321 is a decay spiral blade having three cyclic decay spiral blade surfaces, and the thickness of the decay spiral blade is uniformly 2 mm. The cycle, the thickness and the like of the decay spiral blade can be appropriately set in accordance with a toner conveying speed; the size of the toner cartridge 200, and the like. For example, the thickness of the decay spiral blade used as the discharge blade 321 can be appropriately set within the range of 1 mm to 3 mm.

Note that, in this embodiment, only a continuous decay spiral blade is provided as the discharge blade 321 on the side surface of the rotation shaft 322, however, as an other embodiment, a common spiral blade may be provided on an upstream side in the discharge direction H₁ from the discharge blade 321 on the side surface of the rotation shaft 322.

In this embodiment, the discharge blade 321 is a decay spiral blade as described above. Here, in general, when a toner cartridge is transported or left unused for a long period, the toner in the toner cartridge decreases in mobility. In the toner cartridge of the related art, when the mobility of toner decreases, the toner is not quickly discharged, whereby a locking phenomenon that the rotation of the discharge member stops occurs. In contrast, the toner discharging device 300 according to this embodiment includes a decay spiral blade as the discharge blade 321, and since in the decay spiral blade, a lead angle of an outer circumferential portion becomes smaller as advancing in the discharge direction H₁, a toner conveying speed slows as advancing in the discharge direction H₁, with the result that toner becomes difficult to be rapidly compressed, and is easily discharged from the discharge port 312. Accordingly, with the toner discharging device 300, it is possible to suppress the occurrence of the locking phenomenon.

In the decay spiral blade, a ratio L_{B}/L_{A} between the maximum value L_{A} of the lead of the outer circumferential portion thereof and the minimum value L_{B} of the lead of the outer circumferential portion thereof is preferably 0.1 or more and 0.3 or less. In this case, the decay spiral blade is further preferably a two-cyclic or more and five-cyclic or less decay spiral blade. When L_{B}/L_{A} is less than 0.1, toner is easily compressed in space surrounded by the decay spiral blade, and as a result, stress occurs against the toner, so that toner characteristics are relatively deteriorated. Further, when L_{B}/L_{A} exceeds 0.3, a toner conveying speed is not sufficiently made slow, and as a result, the toner is easily compressed between the decay spiral blade and the wall portion 313 of the discharge container 310 in a downstream in the discharge direction H₁, and the toner characteristics are relatively deteriorated. Whereas, by using the above-described decay spiral blade, it is possible to discharge toner having good characteristics, while suppressing the occurrence of the locking phenomenon.

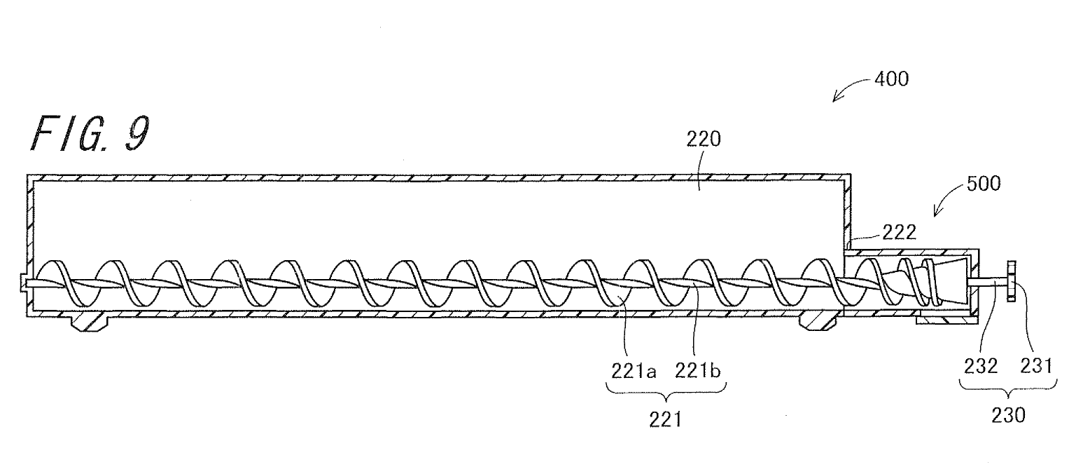

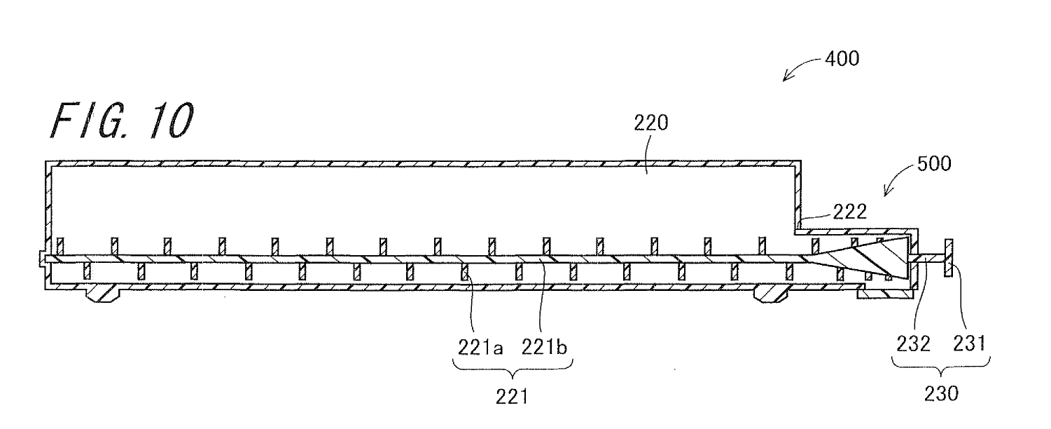

Next, description will be given for a toner cartridge 400 according to a second embodiment. FIG. 9 is a schematic view showing an inner configuration of the toner cartridge 400. FIG. 10 is an end view of the toner cartridge 400. The toner cartridge 400 includes a toner discharging device 500, a storage container 210, a conveying container 220, a scooping member 211, a conveying member 221, and a transmission member 230. Concerning the storage container 210, the conveying container 220, the scooping member 211, the conveying member 221 and the transmission member 230, description is omitted as being in common with the first embodiment.

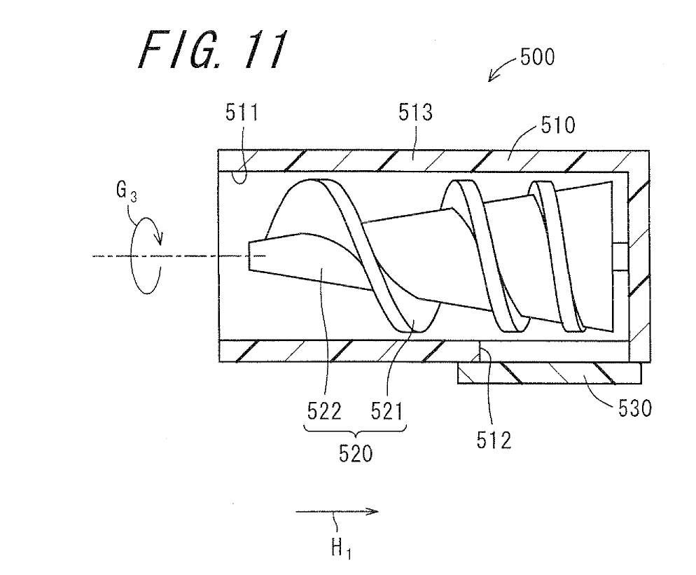

FIG. 11 is a schematic view showing an inner configuration of the toner discharging device 500. The toner discharging device 500 includes a discharge container 510, a discharge member 520 and a shutter member 530. The discharge container 510 is a container-shaped member which has a cylindrical internal space, and comprises a wall portion 513 which defines the internal space and has a reception port 511 for receiving toner which is an opening. The discharge container 510 and the conveying container 220 are connected so that the toner in the conveying container 220 can move into the discharge container 510 through the conveying port 222 and the reception port 511. That is, the internal space of the conveying container 220 and the internal space of the discharge container 510 communicate with each other. The discharge container 510 and the conveying container 220 may be configured as an integral member and may be configured to be detachable.

Additionally, as to the discharge container 510, of the wall portion 513 of the discharge container 510, at least a part of the wall portion 513 surrounding the discharge member 520 (a discharge blade 521 and a rotation shaft 522) along an axial line direction of the discharge member 520 has a discharge port 512 which is an opening for discharging toner. In this embodiment, the discharge port 512 opens in the wall portion 513 facing the vertically lower part of the discharge container 510. In this embodiment, the discharge port 512 is formed in an approximately rectangular shape. The shutter member 530 is provided so as to be slidable on the vertically lower part of the discharge port 512. The shutter member 530 slides in an approximately horizontal direction by coming into contact with the toner supply pipe 250 in a process where the toner cartridge 400 is mounted on a toner cartridge placement table 261, and the discharge port 512 is thereby opened.

The discharge member 520 is a member which is provided in the discharge container 510 so as to discharge the toner entering from the reception port 511 into the discharge container 510 through the discharge port 512. The toner discharged from the discharge port 512 is supplied to the developing device 24 through the toner supply pipe 250.

The discharge member 520 includes a rotation shaft 522 and a discharge blade 521. The rotation shaft 522 is provided so that the axial line thereof is identical to the axial line of the discharge container 510. The rotation shaft 522 has one end connected to the conveying shaft 221b and the other end connected to the transmission member 230. The rotation shaft 522, the conveying shaft 221b, and the transmission member 230 may be configured as an integral member and may be configured to be detachable.

The discharge blade 521 is a member which rotates around the axial line of the rotation shaft 522 following rotation of the rotation shaft 522 in a rotation direction G₃ around an axial line thereof, thus moving the toner in the discharge container 510. The discharge blade 521 on the rotation shaft 522 may continue smoothly into the conveying blade 221a on the conveying shaft 221b, or separate from each other. Description of the discharge member 520 will be provided later.

According to the toner cartridge 400, the toner in the storage container 210 is scooped up into the conveying container 220 by the scooping member 211. Moreover, the transmission shaft 232, the rotation shaft 522, and the conveying shaft 221b are integrally rotated by the torque applied from a driving section (not shown). By the rotation of the conveying shaft 221b, the toner in the conveying container 220 is conveyed into the discharge container 510 through the conveying port 222 and the reception port 511. By the rotation of the rotation shaft 522, the toner in the discharge container 510 is discharged from the discharge port 512 and supplied into the developer tank of the developing device 24.

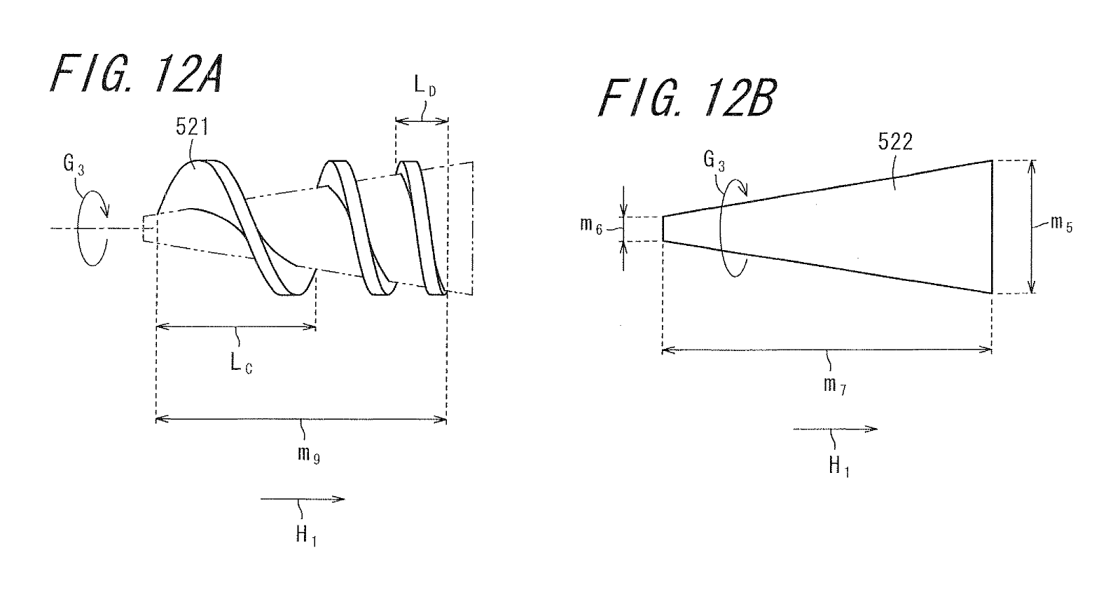

Next, description will be given for the discharge blade 521 and the rotation shaft 522. FIG. 12A is a diagram showing the discharge blade 521, and FIG. 12B is a diagram the rotation shaft 522. In FIG. 12A, the discharge blade 521 is depicted by a solid line, and the rotation shaft 522 is depicted by a two-dotted chain line. In FIG. 12B, only the rotation shaft 522 is depicted by a solid line.

As shown in FIG. 12A, the discharge blade 521 is provided around the rotation shaft 522. The discharge blade 521 rotates around the axial line of the rotation shaft 522 following the rotation of the rotation shaft 522 in the rotation direction G₃. By the rotation, the discharge blade 521 conveys toner in the discharge container 510 in a direction H₁ directed from the reception port 511 to the discharge port 512, of the axial line direction of the rotation shaft 522.

As shown in FIG. 12B, the rotation shaft 522 is a truncated-cone-shaped rotation shaft whose external diameter continuously becomes larger as advancing in the discharge direction H₁. In this embodiment, a “truncated-cone” is a solid having two bottom surfaces whose areas are different from each other (a bottom surface whose area is relatively small is referred to as “small bottom surface”, and a bottom surface whose area is relatively large is referred to as “large bottom surface”), whose axial line runs through the two bottom surfaces (the small bottom surface and the large bottom surface), and whose external diameter continuously becomes larger as advancing in an axial direction thereof that goes from the small bottom surface to the large bottom surface. Then, in this embodiment, the “truncated-cone-shaped rotation shaft” refers to a rotation shaft, whose appearance shape is a truncated-cone shape, that rotates around the axial line thereof.

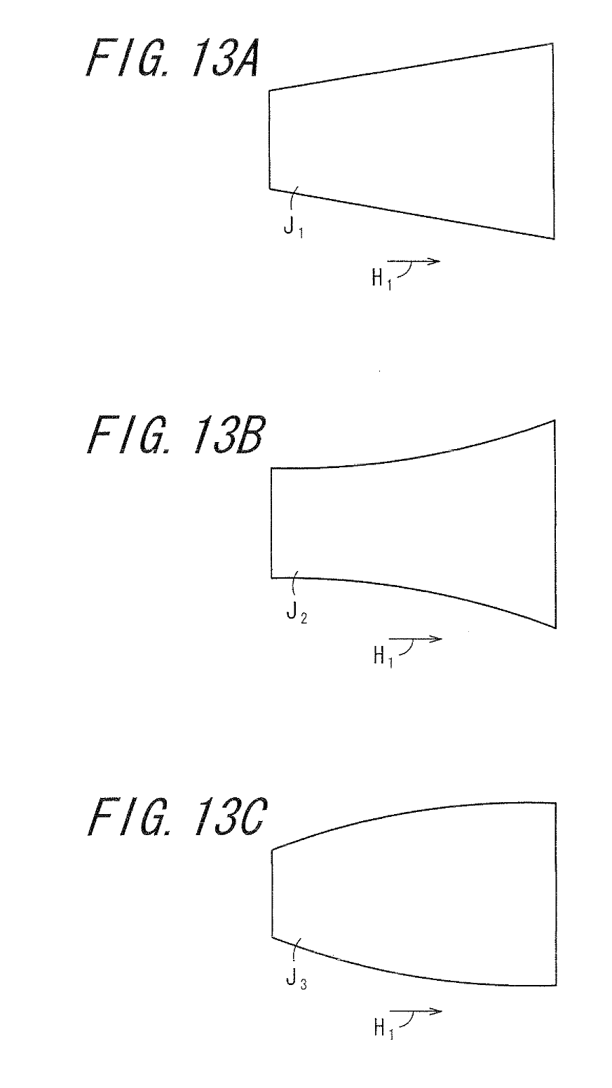

FIGS. 13A to 13C show examples of the truncated-cone-shaped rotation shaft. FIG. 13A shows a side surface of a right circular truncated-cone shaped rotation shaft J₁ that is one of the truncated-cone-shaped rotation shafts. In this embodiment, a “right circular truncated cone” is a solid that is not a circular cone of solids obtained by dividing the right circular cone in two parts by a plane parallel to a bottom surface. Then, in this embodiment, the “right circular truncated-cone shaped rotation shaft” refers to a rotation shaft whose appearance shape is a right circular truncated-cone shape. FIG. 13B shows a side surface of a compression right circular truncated-cone shaped rotation shaft J₂ that is one of the truncated-cone-shaped rotation shafts. In this embodiment, a “compression right circular truncated cone” is a solid in a shape in which a side surface of the right circular truncated cone is curved in a direction that comes close to an axial line thereof. Then, in this embodiment, the “compression right circular truncated-cone shaped rotation shaft” refers to a rotation shaft whose appearance shape is a compression right circular truncated-cone shape. FIG. 13C shows a side surface of an expansion right circular truncated-cone shaped rotation shaft J₃ that is one of the truncated-cone-shaped rotation shafts. In this embodiment, an “expansion right circular truncated cone” is a solid in a shape in which the side surface of the right circular truncated cone is curved in a direction that separates from an axial line thereof. Then, in this embodiment, the “expansion right circular truncated-cone shaped rotation shaft” refers to a rotation shaft whose appearance shape is an expansion right circular truncated-cone shape.

In this manner, in this embodiment, the rotation shaft 522 is a rotation shaft whose appearance shape is a truncated-cone shape. The rotation shaft 522 in a truncated-cone shape is provided so that an external diameter thereof becomes larger as advancing in the discharge direction H₁. Accordingly, toner conveyed by the discharge blade 521 is biased in a direction that separates from the axial line of the rotation shaft 522. Toner flow thereby turns in the direction that separates from the rotation shaft 522. The discharge port 512 is provided at the wall portion 513 surrounding the rotation shaft 522 and the discharge blade 521 along the axial line direction of the rotation shaft 522, and the toner moves in the direction that separates from the axial line of the rotation shaft 522, that is, a direction that comes close to the discharge port 512. Therefore, with the toner discharging device 500 provided with the rotation shaft 522, it is possible to discharge the toner more easily from the discharge port 512.

As the rotation shaft 522, the compression right circular truncated-cone shaped rotation shaft J₂ is more preferable. The compression right circular truncated cone shaped rotation shaft J₂ can turn more gently the flow of toner conveyed with the conveying member 221 in the direction that separates from the rotation shaft 522, compared to the right circular truncated-cone shaped rotation shaft J₁ and the expansion right circular truncated-cone shaped rotation shaft J₃, so that it is possible to suppress a sharp rise of driving torque.

In the truncated-shaped rotation shaft 522, a maximum value of an external diameter thereof, that is, an external diameter m₅ on a large bottom surface is preferably 0.8 time or more and 0.95 time or less a diameter of the cylindrical internal space of the discharge container 510. The external diameter m₅ on the large bottom surface of the rotation shaft 522 falls within this range so that space between the rotation shaft 522 and an inner wall surface of the discharge container 510 becomes an appropriate size, and it is thus possible to enhance discharge efficiency of toner.

Further, in the truncated-shaped rotation shaft 522, (m₅−m₆)/m₇ that is a value in which a difference between the external diameter m₅ on the large bottom surface and the external diameter m₆ on the small bottom surface is divided by a distance m₇ from the large bottom surface to the small bottom surface is preferably 2 or more and 8 or less. When (m₅−m₆)/m₇ is less than 2, a volumetric change of a clearance formed between the discharge member 520 and the wall portion 513 surrounding the same is small, and an effect for pushing out toner is difficult to be obtained. When (m₅−m₆)/m₇ exceeds 8, the volumetric change of the clearance formed between the discharge member 520 and the wall portion 513 surrounding the same excessively becomes larger, and pressure of the toner rises sharply, and a load applied to the toner thus becomes larger. The rotation shaft 522 is configured so as to fall within the above-described range so that the toner can be discharged without applying a load to toner, and the toner discharging device 500 can be downsized. Note that, in this embodiment, the external diameter m₆ on the small bottom surface of the rotation shaft 522 is equal to the external diameter of the conveying shaft 221b, and their axial lines are identical to each other.

The discharge blade 521 is formed of a material, for example, such as polyethylene, polypropylene, high-impact polystyrene or an ABS resin. In this embodiment, the discharge blade 521 is a continuous annular decay spiral blade. The annular decay spiral blade is provided around the rotation shaft 522 in an inner circumferential portion thereof.

In this embodiment, the “annular decay spiral blade” is a special decay spiral blade, and schematically a member in a shape in which an internal diameter is continuously changed while maintaining an external diameter constant in a common spiral blade, and a lead of an outer circumferential portion of the common spiral blade is changed. More specifically, the annular decay spiral blade is a member with a predetermined thickness having an annular decay spiral blade surface as a main surface. Here, the inner circumferential portion of the annular decay spiral blade is a closest part to the axial line of the rotation shaft 522 of the above-described annular decay spiral blade surface, and the outer circumferential portion of the annular decay spiral blade is a farthest part from the rotation shaft 522 of the above-described annular decay spiral blade surface. A shape of the annular decay spiral blade surface is a shape in which the inner circumferential portion and the outer circumferential portion are imaginary decay spirals that are different from each other, which will be described in detail below. Note that, hereinafter, a lead of the outer circumferential portion of the annular decay spiral blade surface that is a main surface of the annular decay spiral blade is referred to as a lead of the outer circumferential portion of the annular decay spiral blade.

In this embodiment, the “annular decay spiral blade surface” is a surface formed by the trajectory of one line segment L₃ inside an imaginary circular column K₅ (hereinafter a radius is r₃) when the line segment L₃ is moved in one direction D₃ parallel to an axial line of the imaginary circular column K₅ while changing so that a length m₅ of the line segment L₃ in a radial direction of the imaginary circular column K₅ continuously becomes smaller and maintaining an attachment angle δ of the line segment L₃ along one decay spiral C₅ (hereinafter, a lead angle continuously becomes smaller from θ₇ to θ₈) on a side surface of the imaginary circular column K₅. The “attachment angle δ” is an angle formed by the line segment L₃ and a half-line extending in the one direction D₃ from a tangent point of the line segment L₃ and the imaginary circular column K₅ on a plane including the axial line of the imaginary circular column K₅ and the line segment L₃, and is an angle that is larger than 0° and smaller than 180°.

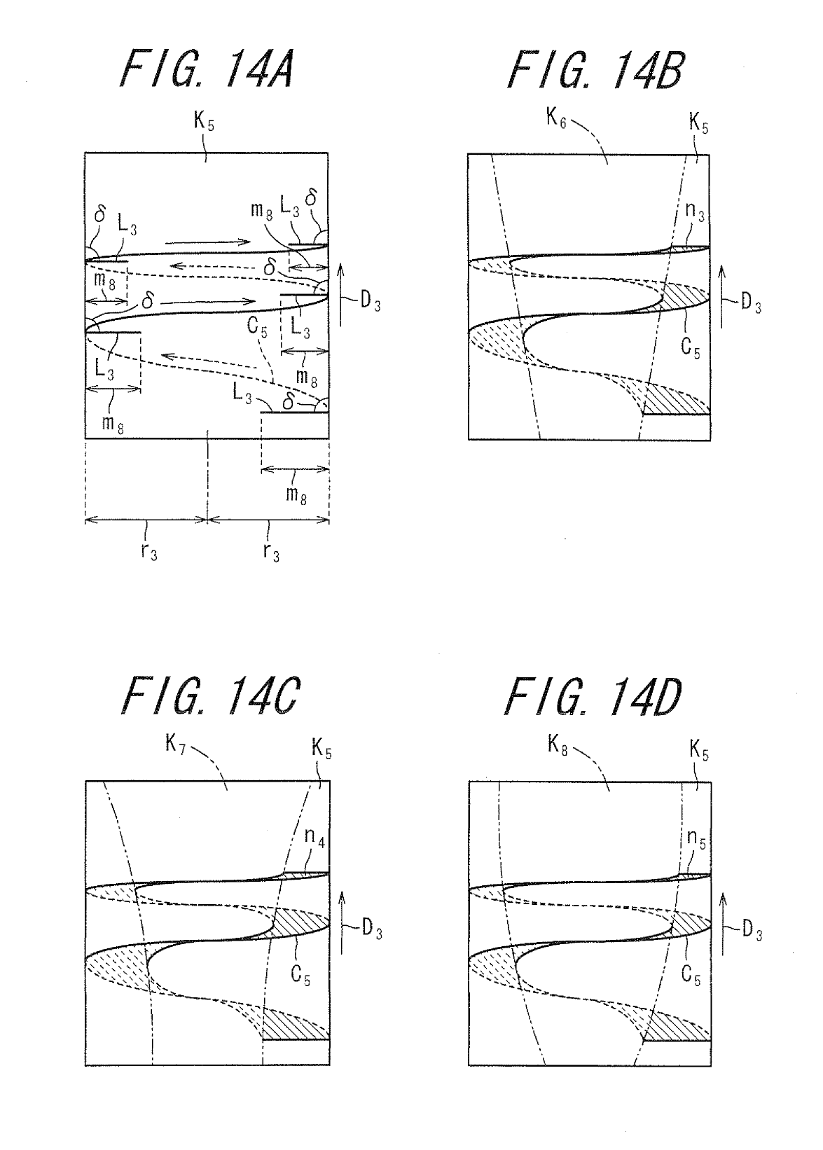

Hereinafter, as an example of the annular decay spiral blade surface, an annular decay spiral blade surface obtained when a line segment is moved along a two cyclic portion of a decay spiral (“two cyclic annular decay spiral blade surfaces”; the same applies to the other cycles) is illustrated. FIGS. 14A to 14D are diagrams illustrating the two cyclic annular decay spiral blade surfaces. FIG. 14A shows a side surface of the imaginary circular column K₅, a decay spiral C₅ on the side surface of the imaginary circular column K₅ and starting and end positions of the line segment L₃ moving in the one direction D₃ on the decay spiral C₅. The line segment L₃ shown on the lowermost side of the sheet surface of FIG. 14A indicates the starting position in moving, and the line segment L₃ shown on the uppermost side indicates the end position. As shown in FIG. 14A, the trajectory of the line segment L₃ when the line segment L₃ is moved in the one direction D₃ along the decay spiral C₅ while changing so that a length m₈ of the line segment L₃ in a radial direction of the imaginary circular column K₅ continuously becomes smaller and constantly maintaining the attachment angle δ (δ=90° in FIG. 14A) of the line segment L₃ corresponds to an annular decay spiral blade surface.

As shown in FIGS. 14B to 14D, an inner circumferential portion of the annular decay spiral blade surface becomes a decay spiral that advances in the one direction D₃ on the side surface of an imaginary truncated cone whose axial line is identical to that of the imaginary circular column K₅. Depending on a way of changing a length m₈ of the line segment L₃, a shape of the imaginary truncated cone in which the annular decay spiral blade surface is circumscribed is different.

FIG. 14B shows an annular decay spiral blade surface n₃ circumscribing an imaginary right circular truncated cone K₆. The trajectory of the line L₃ when a change rate of the length m₈ of the line segment L₃ per unit moving distance along the decay spiral C₅ is constant corresponds to the annular decay spiral blade surface n₃ depicted by a hatched portion in FIG. 14B, and an inner circumferential portion thereof circumscribes a side surface of the imaginary right circular truncated cone K₆.

FIG. 14C shows an annular decay spiral blade surface n₄ circumscribing an imaginary compression right circular truncated cone K₇. The trajectory of the line segment L₃ when a change rate of the length m₈ of the line segment L₃ per unit moving distance along the decay spiral C₅ gradually becomes larger as advancing in the one direction D₃ corresponds to the annular decay spiral blade surface n₄ depicted by a hatched portion in FIG. 14C, and an inner circumferential portion thereof circumscribes a side surface of the imaginary compression right circular truncated cone K₇.

FIG. 14D shows an annular decay spiral blade surface n₅ circumscribing an imaginary expansion right circular truncated cone K₈. The trajectory of the line segment L₃ when a change rate of the length m₈ of the line segment L₃ per unit moving distance along the decay spiral C₅ gradually becomes smaller as advancing in the one direction D₃ corresponds to the annular decay spiral blade surface n₅ depicted by a hatched portion in FIG. 14D, and an inner circumferential portion thereof circumscribes a side surface of the imaginary expansion right circular truncated cone K₈.

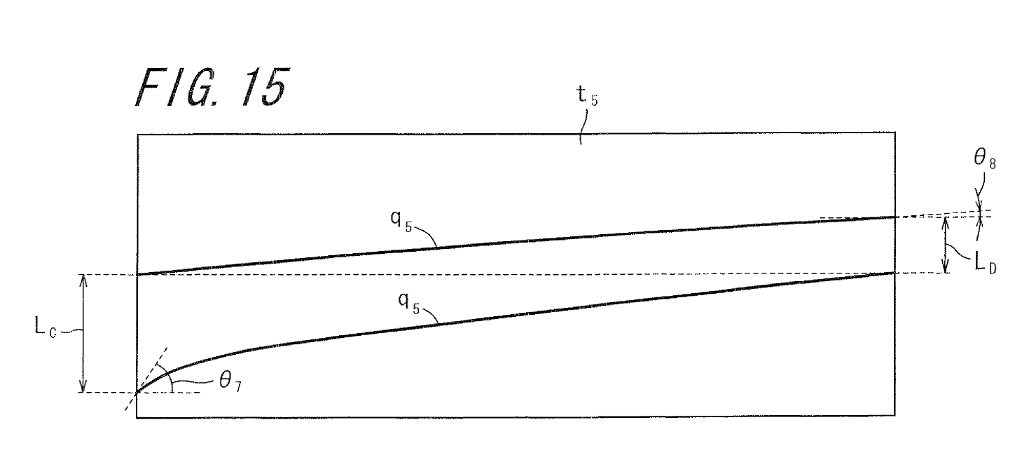

A rectangle t₅ corresponding to the side surface of the imaginary circular column K₅ at the time of developing the imaginary circular column K₅ is shown in FIG. 15. As shown in FIG. 15, a line corresponding to the decay spiral C₅ becomes a smooth curve line q₅ obliquely extending in the rectangle t₅. The lead angle θ₇ becomes an angle of an initial slope of the curve line q₅, and the lead angle θ₈ becomes an angle of a last slope of the curve line q₅. Moreover, a maximum value L_{C} of a lead of the decay spiral C₅ becomes an initial interval of the curve line q₅ in the one direction D₃, and a minimum value L_{D} of the lead of the decay spiral C₅ becomes a last interval of the curve line q₅ in the one direction D₃.

A member with such an annular decay spiral blade surface as a main surface is an annular decay spiral blade. The annular decay spiral blade is, in the case of being used as the discharge blade 521 as in this embodiment, provided so that the annular decay spiral blade surface n₃, n₄ or n₅ is placed on a side of the discharge port 512 in an axial line direction of the rotation shaft 522, and provided so as to convey toner in the discharge direction H₁ with the annular decay spiral blade surface n₃, n₄ or n₅. Additionally, the annular decay spiral blade is provided so that the rotation shaft 522 is present on an inner side from a side surface of the imaginary truncated cone circumscribing in the inner circumferential portion thereof. At the time, the rotation shaft 522 and the discharge blade 521 may be connected by means of a resin, a metal or the like at one or more adjacent parts.

When the discharge blade 521 is the annular decay spiral blade, an external diameter of the discharge blade 521, that is, a value twice a distance between an outer circumferential portion of the discharge blade 521 and an axial line of the rotation shaft 522 uniformly becomes 2r₃, and an internal diameter of the discharge blade 521, that is, a value twice a distance between an inner circumferential portion of the discharge blade 521 and the axial line of the rotation shaft 522 continuously changes from a minimum value of 2m₈+2r₃ to a maximum value of 2m₈+2r₃ as advancing in the discharge direction H₁. A minimum value of the length m₈ can be appropriately set, for example, within a range of 0 mm to 2 mm. A maximum value of the length m₈ can be appropriately set, for example, within a range of 4 mm to 10 mm. Note that, in this embodiment, a maximum value of the external diameter of the discharge blade 521 is equal to the external diameter of the conveying blade 221a of the conveying member 221, and the discharge blade 521 continues smoothly into the conveying blade 221a. Additionally, an entire length m₈ of the discharge blade 521 (annular decay spiral blade) in the axial line direction of the rotation shaft 522 can be appropriately set, for example, within a range of 15 mm to 50 mm.

Further, for example, the attachment angle δ does not need to be 90°, and can be appropriately set in a range of 30° to 150°. The initial lead angle θ₇ of the outer circumferential portion of the annular decay spiral blade can be appropriately set, for example, in a range of 20° to 70°, and the last lead angle θ₈ of the outer circumferential portion can be appropriately set, for example, in a range of 0° to 60°. In this embodiment, the initial lead angle θ₇ of the outer circumferential portion of the annular decay spiral blade is the same as the lead angle θ₂ of the outer circumferential portion of the conveying blade 221a. Note that, the lead angle θ₇ may be set smaller than the lead angle θ₂.

Additionally, in this embodiment, the discharge blade 521 is an annular decay spiral blade having three cyclic annular decay spiral blade surfaces, and a thickness of the annular decay spiral blade is uniformly 2 mm. The cycle, the thickness and the like of the common spiral blade can be appropriately set in accordance with a toner conveying speed, the size of the toner cartridge 400, and the like. For example, the thickness of the annular decay spiral blade used as the discharge blade 521 can be appropriately set within the range of 1 mm to 3 mm.

Note that, in this embodiment, only a continuous annular decay spiral blade is provided as the discharge blade 521 on the side surface of the rotation shaft 522, however, as an other embodiment, a common spiral blade may be provided on an upstream side of the discharge direction H₁ from the discharge blade 521 on the side surface of the rotation shaft 522.

In this embodiment, the discharge blade 521 is an annular decay spiral blade as described above. Since in the annular decay spiral blade, a lead angle of the outer circumferential portion becomes smaller as advancing in the discharge direction H₁, a toner conveying speed slows as advancing in the discharge direction H₁, with the result that toner becomes difficult to be rapidly compressed, and is easily discharged from the discharge port 512. Accordingly, with the toner discharging device 500 provided with the discharge blade 521, it is possible to suppress the occurrence of the locking phenomenon.

Further, the discharge blade 521 as an annular decay spiral blade, whose external diameter is constant, and whose internal diameter continuously becomes larger as advancing in the discharge direction H₁. Accordingly, it is possible to make a clearance between the discharge blade 521 and the rotation shaft 522 small, and this makes it possible to disperse a load applied to toner.

Note that, when the annular decay spiral blade is used as the discharge blade 521, it is preferred to be configured so that an appearance shape of an imaginary truncated cone in which the annular decay spiral blade is circumscribed is identical to that of the truncated-cone-shaped rotation shaft 522. The imaginary truncated cone in which the discharge blade 521 is circumscribed may be made larger than the rotation shaft 522, or the discharge blade 521 may be a decay spiral blade other than the annular decay spiral blade, however, by configuring so that the imaginary truncated cone in which the annular decay spiral blade is circumscribed is identical to the rotation shaft 522, it is possible to further disperse a load applied to toner since a clearance between the rotation shaft 522 and the discharge blade 521 disappears when the discharge member 520 is viewed from a position that separates in the axial line direction of the rotation shaft 522.

In the annular decay spiral blade, a ratio L_{D}/L_{C} between the maximum value L_{C} of the lead of the outer circumferential portion thereof and the minimum value L_{D} of the lead of the outer circumferential portion thereof is preferably 0.1 or more and 0.3 or less. In this case, the annular decay spiral blade is further preferably a two-cyclic or more and five-cyclic or less annular decay spiral blade. When the L_{D}/L_{C} is less than 0.1, toner is easily compressed in space surrounded by the annular decay spiral blade, and as a result, stress occurs against the toner, so that toner characteristics are relatively deteriorated. Moreover, when the L_{D}/L_{C} exceeds 0.3, a toner conveying speed is not sufficiently made slow, and as a result, the toner is easily compressed between the annular decay spiral blade and the wall portion 513 of the discharge container 510 in a downstream in the discharge direction H₁, and the toner characteristics are relatively deteriorated. Whereas, by using the above-described annular decay spiral blade, it is possible to discharge toner having good characteristics, while suppressing the occurrence of the locking phenomenon.

The rotation shaft 522 may be formed of the same material as that of the discharge blade 521, however, it is preferable that at least a surface part thereof is formed of an elastic sponge. In this embodiment, the “elastic sponge” is a material with a compression deformation rate of 50% or more and 80% or less. Here, the compression deformation rate is a value given by the following expression (1), where F[cm] represents a minimum value of a thickness of a cubic sample with 1 cm of each side when a load at 0.1 N/cm²/second is applied in a thickness direction with respect to the sample.

Compression deformation rate [%]=(1−F)×100 [%] (1)

By forming the rotation shaft 522 of such an elastic sponge, it is possible to suppress a load applied to toner due to turn of toner flow. This makes it possible that an image forming apparatus 100 forms a high-quality image stably for a long period of time.

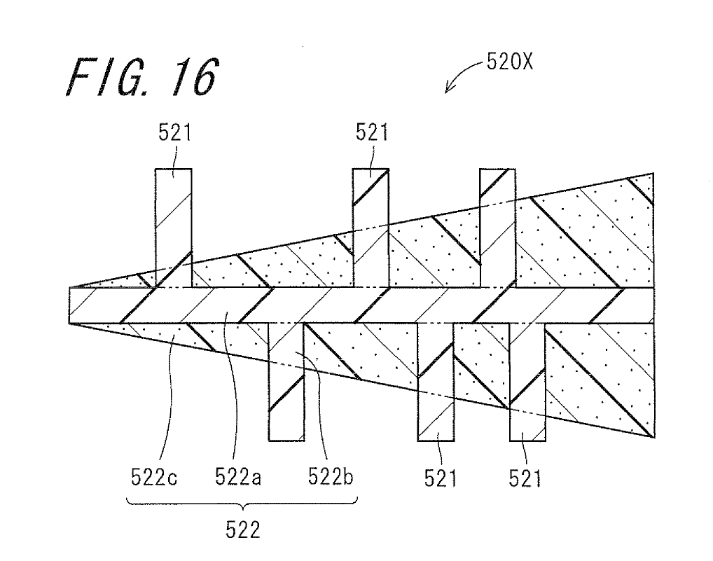

Hereinafter, an example of a discharge member 520X including the rotation shaft 522 whose surface part is formed of an elastic sponge is illustrated. FIG. 16 is an end view of the discharge member 520X cut along an end face line running through an axial line of the rotation shaft 522. The discharge member 520X shown in FIG. 16 includes the discharge blade 521 as an annular decay spiral blade and the rotation shaft 522 as a truncated-cone-shaped rotation shaft. The rotation shaft 522 includes a shaft center section 522a that is a columnar part including an axial line of the rotation shaft 522, a connection section 522b that connects the shaft center section 522a and the discharge blade 521, and an outer circumferential section 522c that is a part excluding the shaft center section 522a and the connection section 522b in the truncated-cone-shaped rotation shaft 522.

In the discharge member 520X shown in FIG. 16, only the outer circumferential section 522c is formed of an elastic sponge, and the discharge blade 521, the shaft center section 522a and the connection section 522b are integrally molded from a material which is relatively more rigid than the elastic sponge. More specifically, the discharge blade 521 and the connection section 522b are integrally provided around the shaft center section 522a, and form a decay spiral blade whose internal diameter is constant, and the connection section 522b and the shaft center section 522a are covered with the outer circumferential section 522c, so that it is configured so as to expose only the discharge blade 521 as an annular decay spiral blade.

The discharge blade 521, the shaft center section 522a and the connection section 522b are integrally molded in this manner, so that strength of the discharge member 520X is improved, and it is also possible to manufacture the discharge member 520X easily. Further, as described above, only the outer circumferential section 522c is formed of an elastic sponge that is a material that is relatively less rigid than other members, and it is thus possible to guide toner to the discharge port 512 more securely after reducing a load applied to toner.

The openings of the elastic sponge preferably have such a size that the toner cannot enter into the opening. Specifically, an opening area is 1 μm² or more and 10 μm² or less. Moreover, an opening diameter is 1 μm or more and 3 μm or less, for example. By forming openings having such a size, it is possible to increase the abrasion between the toner and the elastic sponge while preventing the toner from entering into the openings. In this way, the toner can easily rotate together with the discharge blade 521. Therefore, even when the mobility of toner decreases, it is possible to move the toner and suppress an increase of the driving torque.

As for the elastic sponge, a urethane sponge, a rubber sponge, a polyethylene sponge, and the like can be used, and among these, the urethane sponge having excellent abrasion resistance is preferred. The use of a urethane sponge as the elastic sponge enables the life of the toner cartridge 400 to be extended. Moreover, as the elastic sponge, a continuous foam sponge having continuous foams is preferred. Since the continuous foam sponge is easily compressed or deformed compared to a single foam sponge, it is possible to suppress the excessive compression of toner. The continuous foam sponge is obtained by a method of subjecting a kneaded material of fine calcium carbonate particles to injection molding and dipping the molded product into a hydrochloric acid solution, thus decomposing and eluting calcium carbonate powder. Alternatively, a method of molding a kneaded material of water-soluble salt and eluting the salt in water to obtain a continuous foam structure, and a method of adding a foaming agent in a resin in advance and physically breaking the walls of foams after the foaming process may be used.

Furthermore, as the elastic sponge, a conductive sponge containing a conductive agent such as carbon black is preferred. Since the conductive sponge is hard to be charged even when it is brushed on the toner or against the inner wall surface of the discharge container 310, it is possible to suppress the toner from being electrostatically absorbed to the conductive sponge.

The technology may be embodied in other specific forms without departing from the spirit or essential characteristics thereof. The present embodiments are therefore to be considered in all respects as illustrative and not restrictive, the scope of the technology being indicated by the appended claims rather than by the foregoing description and all changes which come within the meaning and the range of equivalency of the claims are therefore intended to be embraced therein.

What is claimed is:

1. A toner discharging device comprising:
a discharge container comprising a wall portion which defines an internal space thereof and has a reception port for receiving toner and a discharge port for discharging toner; and
a discharge member provided in the discharge container, the discharge member including:
a rotation shaft, and
a discharge blade provided around the rotation shaft, the discharge blade moving, according to rotation motion following rotation of the rotation shaft, the toner in the discharge container in a discharge direction that is an axial line direction of the rotation shaft that goes from the reception port to the discharge port, the discharge blade being a decay spiral blade whose lead angle of an outer circumferential portion thereof becomes smaller as advancing in the discharge direction,
at least a part of the wall portion of the discharge container surrounding the decay spiral blade along the axial line direction of the rotation shaft, and the discharge port being formed on the part of the wall portion.

2. The toner discharging device of claim 1, wherein the decay spiral blade is an annular decay spiral blade whose external diameter is constant, and whose internal diameter continuously becomes larger as advancing in the discharge direction, and
the rotation shaft is a truncated-cone-shaped rotation shaft whose external diameter continuously becomes larger as advancing in the discharge direction.

3. The toner discharging device of claim 2, wherein a surface part of the truncated-cone-shaped rotation shaft is formed of an elastic sponge.

4. The toner discharging device of claim 2, wherein the discharge container has a cylindrical internal space, and is configured so that an axial line direction of the cylindrical internal space is identical to an axial line direction of the truncated-cone-shaped rotation shaft, and
the truncated-cone-shaped rotation shaft is configured so that a maximum value of the external diameter thereof is 0.8 time or more and 0.95 time or less a diameter of the cylindrical internal space.

5. The toner discharging device of claim 1, wherein, in the decay spiral blade, a ratio L_{B}/L_{A} between a maximum value L_{A} of the lead of the outer circumferential portion thereof and a minimum value L_{B} of the lead of the outer circumferential portion thereof, is 0.1 or more and 0.3 or less.

6. A toner cartridge comprising:
the toner discharging device of claim 1;
a storage container that stores toner;
a conveying container having a conveying port through which the toner is conveyed to the discharge container;
a scooping member which is provided in the storage container so as to scoop up the toner in the storage container into the conveying container; and
a conveying member which is provided in the conveying container so as to convey the toner in the conveying container towards the conveying port,
the discharge container and the conveying container being connected so that the toner in the conveying container can be moved to the discharge container through the conveying port and the reception port.

7. An electrophotographic image forming apparatus comprising a developing device,
the toner cartridge of claim 6 being provided as a toner cartridge for supplying toner to the developing device.
